(19) United States
(12) Patent Application Publication
(10) Pub. No.: US 2026/0281159 A1
(43) Pub. Date: Sep. 17, 2026

(54) MANAGED TRANSPORTATION COMMUNICATION AUTHORIZATION, GOVERNANCE, ACCESSIBILITY, MULTIMODAL COMMUNICATION SYNCHRONIZATION, AND NETWORK RESOURCE CONTROL SYSTEM

(71) Applicant: Quiet, Inc., La Jolla, CA (US)

(72) Inventor: Scott A. Moser, La Jolla, CA (US)

(21) Appl. No.: 19/679,603

(22) Filed: May 15, 2026

Related U.S. Application Data
(63) Continuation-in-part of application No. 19/287,882, filed on Aug. 1, 2025.
Application No. 19/287,882 is a continuation-in-part of application No. 18/215,546, filed on Jun. 28, 2023, now Pat. No. 12,445,761.
Application No. 18/215,546 is a continuation-in-part of application No. 17/700,069, filed on Mar. 21, 2022, now Pat. No. 11,785,375.
(60) Provisional application No. 63/210,631, filed on Jun. 15, 2021.

(51) Int. Cl. H04L 9/40; H04L 9/32

(52) U.S. Cl. CPC H04L 63/166; H04L 9/3213; H04L 63/0876; H04L 63/104

(57) ABSTRACT

A transportation-provider-managed communication system configured to selectively authorize, synchronize, govern, prioritize, monetize, monitor, revoke, suspend, terminate, interpret, render, process, synchronize, optimize, allocate, meter, or control multimodal communication sessions and accessibility communication sessions operating within transportation-provider-managed communication environments. The system comprises onboard wireless communication infrastructures, communication authorization systems, transportation-provider-managed communication governance systems, accessibility communication rendering systems, interpreted speech systems, synchronized caption systems, distributed rehabilitation systems, conferencing systems, browser-based communication systems, network resource allocation systems, and passenger-operated portable electronic communication devices. Communication sessions may comprise Voice over Internet Protocol communication sessions, conferencing sessions, collaboration sessions, browser communication sessions, telehealth sessions, accessibility communication sessions, synchronized communication sessions, or combinations thereof.

### CROSS-REFERENCE TO RELATED APPLICATIONS

This is a continuation-in-part of a patent family held by Quiet, Inc., which establishes a foundational system for secure, private communication and assistive speech technology. Specifically, this application is a continuation-in-part of U.S. Patent Application Serial No. 19/287,882, entitled "Precisely Controlled Microphone Acoustic Attenuator with Protective Microphone Enclosure," filed Aug. 1, 2025, which is a continuation-in-part of U.S. Patent Application Serial No. 18/215,546, filed Jun. 28, 2023, which is a continuation-in-part of U.S. Patent Application Serial No. 17/700,069, filed Mar. 21, 2022, and further claims priority to U.S. Provisional Patent Application Serial No. 63/210,631, filed Jun. 15, 2021. Each of these priority applications in the priority chain are hereby incorporated herein by reference in their entirety.

### FIELD OF THE INVENTION

The disclosed subject matter generally relates to transportation-provider-managed communication systems, governed real-time communication infrastructures, and transportation communication resource management systems.

More particularly, the disclosed subject matter relates to systems and methods configured to selectively authorize, govern, synchronize, prioritize, monetize, monitor, revoke, restrict, suspend, terminate, interpret, render, process, synchronize, optimize, allocate, or control communication sessions operating within transportation-provider-managed communication environments.

In certain embodiments, the disclosed subject matter relates to passenger-operated portable electronic communication devices configured to communicate through transportation-provider-managed communication infrastructures using wireless communication systems, Voice over Internet Protocol communication systems, conferencing communication systems, collaboration communication systems, browser-based communication systems, telehealth communication systems, distributed communication systems, cloud communication systems, synchronized communication systems, or combinations thereof.

In certain embodiments, the disclosed subject matter relates to transportation-provider-managed accessibility communication rendering systems configured to facilitate communication accessibility for users having impaired speech, hearing impairments, visual impairments, neurological communication impairments, articulation impairments, degenerative communication impairments, communication-processing impairments, or combinations thereof.

In certain embodiments, the disclosed subject matter relates to transportation-provider-managed network resource governance systems configured to dynamically allocate communication resources, reduce communication congestion, reduce latency, prioritize accessibility traffic, control bandwidth utilization, synchronize multimodal communication rendering, improve interpreted speech processing performance, and reduce unauthorized communication traffic within transportation-provider-managed communication infrastructures.

### BACKGROUND OF THE INVENTION

Existing transportation communication systems generally provide unmanaged passenger internet access without transportation-provider-managed communication governance, operational communication restrictions, authorization token systems, conferencing governance systems, communication synchronization systems, communication monetization systems, accessibility communication infrastructures, synchronized caption systems, interpreted speech systems, distributed communication synchronization systems, or transportation-provider-managed network resource control systems.

Conventional passenger internet systems typically permit unrestricted communication sessions operating independently of transportation-provider operational governance.

Existing conferencing systems, Voice over Internet Protocol communication systems, browser-based communication systems, enterprise collaboration systems, telehealth communication systems, and distributed cloud communication systems similarly fail to provide transportation-provider-managed communication governance infrastructures configured to selectively authorize, synchronize, prioritize, meter, monetize, suspend, revoke, terminate, allocate bandwidth to, or restrict communication sessions operating within transportation-provider-managed communication environments.

Existing systems additionally fail to adequately support users having impaired speech, hearing impairments, visual impairments, articulation impairments, neurological impairments, communication-processing impairments, or degenerative communication impairments operating within transportation communication environments.

Existing systems further fail to provide transportation-provider-controlled administrative override systems capable of rapidly revoking communication sessions according to operational transportation conditions, safety conditions, transportation-provider communication policies, communication congestion conditions, emergency conditions, or accessibility conditions.

Existing systems additionally fail to provide synchronized multimodal accessibility rendering infrastructures configured to synchronize interpreted speech outputs, synchronized caption outputs, textual outputs, audio outputs, browser-rendered outputs, conferencing outputs, telehealth outputs, or accessibility outputs across heterogeneous communication endpoints operating within transportation communication environments.

Accordingly, a need exists for improved transportation-provider-managed communication systems configured to selectively authorize, synchronize, govern, prioritize, monetize, revoke, suspend, terminate, interpret, render, process, synchronize, optimize, allocate, meter, or control multimodal communication sessions and accessibility communication sessions operating within transportation-provider-managed communication environments.

### DESCRIPTIONS OF RELATED ART

A primary prior art reference, U.S. Patent No. 10,044,842, is by the present inventor and discloses the Quietphone™ concept. This concept utilizes specialized hardware of a phone handset or headset that provides, e.g., an anechoic chamber around a user’s mouth to cancel the noise of a user’s voice for privacy of the user’s phone communications. The Quietphone™ concept contemplated private phone conversations in crowded public places, like hospitals or airplane cabins. Accordingly, this patent also details a critical management feature allowing flight staff or hospital administrators to remotely disable communication devices underlying the Quietphone™ handset or headset in sensitive environments via encrypted RF signals from a wearable remote controller. The present disclosure is distinguished from U.S. Patent No. 10,044,842 in that the present disclosure is not directed to a binary, device-level on/off disablement mechanism, but rather to a comprehensive, multi-layered transportation governance framework capable of selectively authorizing, governing, prioritizing, monetizing, synchronizing, and rendering multimodal communication sessions and accessibility outputs across heterogeneous communication endpoints operating within transportation-provider-managed communication environments.

U.S. Patent No. 10,460,730 B2 (Airbus Operations GmbH) discloses an announcement signaling system for use on board an aircraft in which cabin management systems broadcast audio announcements to passenger seat units and overhead speakers. U.S. Patent Application Publication No. 2016/0372114 A1 and its European counterpart EP 3 107 090 A1 (Airbus Operations GmbH) similarly disclose announcement signaling systems for aircraft cabins. Although these references address transportation-environment communication at the cabin-broadcast level, they are limited to one-way airline-to-passenger announcement signaling and fail to disclose or suggest transportation-provider-managed bidirectional passenger communication authorization, encrypted communication authorization tokens associated with passenger identity, seat assignments, and operational conditions, quality-of-service prioritization of individual passenger communication sessions, synchronized multimodal accessibility rendering, or the multi-layered governance framework of the present disclosure. The present disclosure is further distinguished in that it enables governance and selective authorization of individual passenger-initiated communication sessions—including Voice over Internet Protocol sessions, conferencing sessions, telehealth sessions, and browser-based communication sessions—rather than broadcast-only announcement distribution.

U.S. Patent Application Publication No. 2025/0273197 A1 and its European counterpart EP 4 610 979 A1 (Airbus Operations GmbH) disclose a system and method for speech-to-text conversion of passenger announcements on board an aircraft, wherein crew-initiated announcements are transcribed and rendered as text for display on passenger seat-back screens. While this reference employs speech-to-text processing within an aircraft communication environment and anticipates display of transcribed content to passengers, it is distinguished from the present disclosure in that it is limited to provider-initiated announcement transcription and does not disclose transportation-provider-managed authorization and governance of passenger-initiated communication sessions, communication authorization tokens tied to passenger identity or seat assignments, quality-of-service bandwidth allocation for individual passenger sessions, synchronized multimodal accessibility rendering for passengers with impaired speech, hearing impairments, visual impairments, or other communication disabilities, or the comprehensive transportation governance architecture of the present disclosure.

The physical architecture of the Quietphone™ concept was improved by the current patent family and associated priority documents, including U.S. Patent No. 11,785,375. This patent family discloses a precisely controlled microphone acoustic attenuator and related voice analyzing software. This patent family’s described hardware improves the Quietphone™ concept by allowing for undistorted voice pickup in high sound pressure environments, such as a sealed mask or handset like the Quietphone™ offers, while simultaneously screening “plosive” energy through a diaphragm assembly and protecting the internal circuitry from environmental hazards like debris and humidity. The current patent family, further including U.S. Patent No. 12,445,761, and Published App. No. 2026/0092867, also improved the state of the art by incorporating an “Impaired Speech Analysis and Comparison module” that matches a user’s unintelligible utterances with plosive energy of the utterance removed against a personalized voice database to output clear text or synthetic speech. The parent application, U.S. Patent Application Serial No. 19/287,882 (incorporated herein by reference), discloses the acoustic attenuation hardware and impaired speech rehabilitation software that form the speech acquisition and conditioning foundation for the interpreted speech and accessibility rendering architectures of the present disclosure.

U.S. Patent Application Publication No. 2025/0045859 A1 (NEC Corporation) discloses an information management system that issues tokens per moving body and allocates them to boarding passengers for purposes of information routing within a transportation environment. While this reference employs a token-based allocation mechanism in a transportation context, it is limited to informational routing tokens and does not disclose or suggest communication authorization tokens tied to passenger identity and communication policies, quality-of-service governance of communication sessions, accessibility communication rendering, or the transportation-provider-managed communication governance architecture of the present disclosure.

U.S. Patent No. 6,272,140 B1 (Raytheon BBN Technologies Corp.) discloses bandwidth allocation techniques for wireless personal area networks, and EP 1 851 919 A1 discloses bandwidth allocation for telecommunications networks. These references address general wireless and telecommunications bandwidth allocation mechanisms. They are distinguished from the present disclosure in that they do not disclose transportation-provider-managed communication governance, communication authorization tokens associated with passenger identity and seat assignments, operational transportation condition governance of communication sessions, accessibility-prioritized bandwidth allocation, or the synchronized multimodal accessibility rendering of the present disclosure.

U.S. Patent Application Publication No. 2019/0341023 A1 and U.S. Patent No. 10,803,853 B2 (Optum Services (Ireland) Limited) disclose audio tokenization systems and methods. U.S. Patent No. 12,537,007 B2 and U.S. Patent Application Publication No. 2025/0342839 A1 disclose methods for detecting aircraft air conflicts based on semantic parsing of control speech. These references address audio tokenization and speech semantic processing in contexts distinct from the present disclosure. They are distinguished from the present disclosure in that they do not disclose transportation-provider-managed communication authorization token systems tied to passenger identity, seat assignments, and operational transportation conditions, quality-of-service prioritization of individual passenger communication sessions, or synchronized multimodal accessibility rendering for passengers within a managed transportation communication environment.

U.S. Patent Application Publication No. 2011/0313645 A1 discloses a system and method for aircraft taxiing and guidance using a communication network. While this reference addresses aircraft communication network use, it is limited to ground-operations guidance and does not disclose passenger communication governance, authorization token systems, accessibility rendering, or the multi-layered transportation governance framework of the present disclosure.

This present disclosure further introduces a comprehensive transportation governance system that manages multimodal communication, bandwidth, and accessibility rendering for passengers across heterogeneous network environments, such as airplanes and trains. The distinction in systemic scope between the prior art discussed above and the current subject matter represents a shift from binary device control or announcement distribution to a sophisticated, multi-layered governance framework. The present disclosure introduces a comprehensive Transportation Governance System that actively manages the communication environment, moving beyond simple “on/off” commands or broadcast announcements to oversee multimodal communication streams—integrating voice, text, and visual rendering—while simultaneously implementing intelligent bandwidth allocation. By prioritizing high-priority accessibility traffic, such as real-time speech-to-text, over standard data, the system ensures reliable service for passengers with communication disabilities. Furthermore, this governance layer is designed for heterogeneous networks, enabling the synchronization of passenger accessibility profiles seamlessly across different modes of transit, including aircraft, trains, and buses.

### SUMMARY OF THE INVENTION

The present specification, claims, and drawing architecture have been synchronized to support transportation-provider-managed communication governance systems, encrypted communication authorization token systems, communication reauthorization systems, quality-of-service communication prioritization systems, bandwidth allocation systems, communication congestion mitigation systems, accessibility synchronization systems, heterogeneous endpoint synchronization systems, distributed cloud synchronization systems, edge-computing infrastructures, anti-circumvention governance architectures, rapid administrative override systems, interpreted speech processing systems, and multimodal communication rendering systems.

The disclosed subject matter provides transportation-provider-managed communication systems configured to selectively authorize, synchronize, govern, prioritize, meter, monetize, monitor, revoke, suspend, terminate, interpret, render, process, synchronize, optimize, allocate, or control passenger communication sessions operating within transportation-provider-managed communication environments.

In certain embodiments, the disclosed subject matter comprises onboard wireless communication infrastructures, communication authorization systems, transportation-provider-managed communication governance systems, communication synchronization systems, communication monetization systems, quality-of-service communication prioritization systems, accessibility communication rendering systems, interpreted speech systems, synchronized caption systems, distributed rehabilitation systems, conferencing communication systems, browser-based communication systems, telehealth communication systems, distributed communication synchronization systems, cloud communication systems, network resource allocation systems, communication congestion mitigation systems, or combinations thereof.

Passenger-operated portable electronic communication devices may communicate through transportation-provider-managed communication infrastructures using Voice over Internet Protocol communication systems, conferencing systems, collaboration systems, browser-based communication systems, enterprise collaboration systems, telehealth communication systems, distributed cloud communication systems, synchronized communication systems, or combinations thereof.

Communication authorization systems may generate communication authorization tokens associated with passenger identities, passenger seat assignments, transportation-provider communication policies, accessibility communication classifications, communication durations, monetization classifications, conferencing classifications, subscription classifications, operational transportation conditions, payment confirmation states, reauthorization intervals, cryptographic validation states, or combinations thereof.

Transportation-provider-managed communication governance systems may selectively authorize communication sessions, synchronize communication sessions, meter communication sessions, monetize communication sessions, prioritize communication sessions, suspend communication sessions, revoke communication sessions, terminate communication sessions, allocate network resources to communication sessions, dynamically control communication bandwidth allocations, or restrict communication sessions according to transportation-provider operational policies, operational transportation conditions, communication classifications, monetization classifications, accessibility classifications, conferencing classifications, communication congestion conditions, emergency operational conditions, or combinations thereof.

Accessibility communication rendering systems may generate interpreted speech outputs, synchronized caption outputs, synthesized speech outputs, regenerated speech outputs, visual accessibility outputs, browser-based accessibility outputs, communication accessibility outputs, conferencing accessibility outputs, telehealth accessibility outputs, enterprise collaboration accessibility outputs, multilingual accessibility outputs, synchronized multimodal accessibility outputs, or combinations thereof.

Transportation-provider-managed communication environments may comprise aircraft environments, train environments, rail transportation environments, bus environments, maritime transportation environments, transportation hubs, passenger terminals, fleet transportation systems, distributed transportation systems, or combinations thereof.

The disclosed subject matter may improve transportation communication infrastructures by reducing communication congestion, dynamically prioritizing communication traffic, reducing communication latency, reducing unauthorized communication traffic, synchronizing accessibility rendering outputs across heterogeneous communication endpoints, improving interpreted speech processing accuracy, improving communication reliability, reducing communication instability, and improving transportation-provider operational governance of passenger communication sessions.

### BRIEF DESCRIPTION OF THE DRAWINGS

FIG. 1 illustrates an example transportation-provider-managed communication governance ecosystem.

FIG. 2 illustrates an example passenger communication authorization and token workflow.

FIG. 3 illustrates an example seat-associated authorization and session control workflow.

FIG. 4 illustrates an example operational transportation condition governance workflow.

FIG. 5 illustrates an example administrative override and session revocation workflow.

FIG. 6 illustrates an example device-agnostic passenger communication governance architecture.

FIG. 7 illustrates an example onboard wireless communication infrastructure.

FIG. 8 illustrates an example Voice over Internet Protocol communication routing architecture.

FIG. 9 illustrates an example browser-based conferencing, enterprise collaboration, and telehealth communication governance architecture.

FIG. 10 illustrates an example transportation-provider-managed multimodal communication system.

FIG. 11 illustrates an example quality-of-service prioritization, latency control, and bandwidth allocation architecture.

FIG. 12 illustrates an example monetization, metering, billing, and revenue allocation workflow.

FIG. 13 illustrates an example communication logging and audit infrastructure.

FIG. 14 illustrates an example distributed transportation communication environment synchronization architecture.

FIG. 15 illustrates an example accessibility communication rendering architecture.

FIG. 16 illustrates an example distributed interpreted speech synchronization system.

FIG. 17 illustrates an example user-associated speech model and rehabilitation processing architecture.

FIG. 18 illustrates an example synchronized caption and hearing accessibility workflow.

FIG. 19 illustrates an example vision accessibility and configurable rendering output architecture.

FIG. 20 illustrates an example common interpreted representation synchronization architecture.

FIG. 21 illustrates an example acoustic attenuation speech acquisition support architecture.

FIG. 22 illustrates an example conferencing and collaboration governance system.

FIG. 23 illustrates an example multiuser conferencing synchronization workflow.

FIG. 24 illustrates an example platform-independent conferencing governance architecture.

FIG. 25 illustrates an example accessibility conferencing rendering and synchronization workflow.

FIG. 26 illustrates an example tokenized conferencing authorization and revocation workflow.

FIG. 27 illustrates an example integrated airline communication governance architecture.

FIG. 28 illustrates an example transportation-provider accessibility governance layer.

FIG. 29 illustrates an example distributed cloud communication and accessibility synchronization architecture.

FIG. 30 illustrates an example integrated Track One claim architecture overview.

### COMPONENT LIST

In the figures, the following reference numerals correspond with the associated components of the preferred embodiment:

100 – Transportation Governance System

102 – Passenger Device

104 – Onboard WiFi

106 – Authorization Server

108 – Policy Engine

110 – Remote Network

112 – Accessibility Renderer

114 – Billing/Metering

116 – Audit Log

118 – Crew Console

120 – Session Token

202 – Request Session

204 – Verify Passenger

206 – Check Policy

208 – Payment or Entitlement

210 – Generate Token

212 – Open Session

214 – Monitor or Renew

302 – Passenger Enters Seat ID

304 – Cabin System Validates Seat

306 – Server Binds Token to Seat

308 – Remote Call Established

310 – Session Control Applied

312 – Crew Status Monitored

402 – Monitor Flight or Transport Condition

404 – Restricted Taxi/Takeoff Restricted

406 – Cruise Condition Verified

408 – Turbulence or Emergency Check

410 – Allow Session

412 – Restrict Session

414 – Suspend or End Session

502 – Crew or Admin Console

504 – Select Seat or Session

506 – Override Engine

508 – Revoke Token

510 – Terminate Media

512 – Log Action

514 – Notify Passenger

602 – Smartphone

604 – Tablet

606 – Laptop

608 – Wearable

610 – Quietphone or Acoustic Device

612 – Browser Device

614 – Device-Agnostic Governance Layer

616 – VoIP Control

618 – Conference Control

620 – Telehealth Control

622 – Accessibility Control

702 – Cabin Access Points

704 – Cabin Router

706 – IFC Modem

708 – Satellite or ATG Link

710 – Ground Network

712 – Policy/AAA Server

714 – Crew Console

802 – Passenger Audio

804 – Codec/RTP Stream

806 – VoIP Gateway

808 – QoS Classifier

810 – IFC Link

812 – Remote SIP or VoIP Service

814 – Remote User

902 – Browser Client

904 – Conference App

908 – Transportation Governance Proxy

910 – Policy Check

912 – Token Check

914 – Bandwidth Check

916 – Accessibility Rendering

1000 – Multimodal Communication System

1002 – Voice Input

1004 – Text Input

1006 – Remote Input

1008 – Sensor Input

1010 – Subtitles/Caption Output

1012 – Synthetic Speech

1014 – Visual Rendering

1016 – Accessibility Profile

1102 – Traffic Input

1104 – Traffic Classifier

1106 – Accessibility Priority

1108 – Paid Session Priority

1110 – Standard Data

1112 – Bandwidth Allocator

1114 – Latency Monitor

1116 – IFC Link

1202 – Session Start

1204 – Meter Duration

1206 – Apply Rate

1208 – Process Payment

1210 – Allocate Revenue

1212 – Airline Share

1214 – IFC Share

1216 – Quiet Share

1302 – Session Events

1304 – Token Events

1306 – Crew Actions

1308 – QoS Events

1312 – Audit Database

1314 – Compliance Report

1316 – Security Analytics

1318 – Audit API

1402 – Aircraft A

1404 – Aircraft B

1406 – Train/Bus

1408 – Terminal

1410 – Edge Node

1412 – Cloud Synchronization Core

1414 – Policy Repository

1416 – Accessibility Model

1418 – Sync Log

1502 – Speech Input

1504 – Interpretation Engine

1508 – Visual Renderer

1510A – Audio Renderer

1510B – Braille Renderer

1512 – Haptic Renderer

1514 – Remote Output

1602 – User Speech

1604 – Local Processor

1606 – Cloud Speech Model

1608 – Interpreted Text

1610 – Synthetic Speech

1612 – Caption Stream

1614 – Remote Devices

1702 – User Speech Samples

1704 – User Model Database

1706 – Rehab Training Engine

1708 – Model Update

1710 – Session Speech

1712 – Interpreted Output

1714 – Therapy Feedback

1802 – Voice Audio

1804 – Speech-to-Text

1806 – Timestamp Alignment

1808 – Caption Stream

1810 – Remote Display

1812 – Hearing Access Output

1814 – Sync Feedback

1902 – Communication Content

1904 – Rendering Profile

1906 – Large Text

1908 – High Contrast

1912 – Braille/Haptic Output

1914 – User Display

2002 – Voice

2004 – Text

2006 – Gesture or User Interface

2008 – Common Interpreted Representation

2010 – Caption

2012 – Speech

2014 – Visual

2016 – Remote Endpoint

2102 – User Mouth

2104 – Acoustic Attenuator

2106 – Protected Microphone

2108 – Signal Conditioner

2110 – Wireless Device

2112 – Governance System

2114 – Remote Call

2202 – Participant A

2204 – Participant B

2206 – Participant C

2208 – Conference Service

2210 – Governance Gateway

2212 – Policy Engine

2214 – QoS Manager

2216 – Audit Log

2302 – Join Requests

2304 – Identify Users

2306 – Authorize Each Participant

2308 – Sync Audio/Captions

2310 – Apply QoS

2312 – Monitor Session

2314 – End and Log

2402 – Teams

2404 – Zoom

2406 – Webex

2408 – Browser RTC

2410 – Telehealth

2412 – Platform-Independent Governance Adapter

2414 – Token Control

2416 – QoS Control

2418 – Accessibility Control

2420 – Audit Control

2502 – Conference Audio

2504 – Interpret Speech

2506 – Generate Captions

2508 – Render Accessible Outputs

2510 – Sync Participants

2512 – Adapt Per User

2514 – Log Access Events

2602 – Conference Request

2604 – Issue Token

2606 – Bind Token to User/Seat

2608 – Token Valid/Revoked

2610 – Monitor Validity

2612 – Revoke Token

2614 – Block Media

2702 – Passenger Seat

2704 – Cabin Wi-Fi

2706 – IFC System

2708 – Airline Policy Server

2710 – Crew Console

2712 – Payment System

2714 – Accessibility System

2716 – Remote Network

2802 – Passenger Communication Apps

2804 – Accessibility Rendering Services

2806 – Transportation-Provider Accessibility Governance Layer

2808 – Authorization/Policy/QoS

2810 – Onboard Network and IFC Infrastructure

2902 – Onboard Edge

2904 – Cloud Service

2906 – Speech Model Cloud

2908 – Caption Service

2910 – Policy Service

2912 – Remote Users

2914 – Audit Store

3002 – Claim 1 Method

3004 – Claim 13 System

3006 – Claim 21 Non-Transitory Medium

3008 – Claim 26 Cloud/Edge System

3010 – Dependent Claims: Accessibility, QoS, Tokens, Revocation

### DETAILED DESCRIPTION OF THE INVENTION

The disclosed figures collectively illustrate coordinated transportation-provider-managed communication governance infrastructures configured to selectively authorize, synchronize, govern, prioritize, monetize, monitor, revoke, suspend, terminate, interpret, render, process, synchronize, optimize, allocate, or control multimodal communication sessions and accessibility communication sessions operating within transportation-provider-managed communication environments.

Passenger-operated portable electronic communication devices may comprise smartphones, cellular telephones, tablet computers, laptop computers, conferencing terminals, browser-enabled communication devices, accessibility communication devices, acoustic attenuation communication devices, wearable communication devices, or combinations thereof.

Transportation-provider-managed communication governance systems may selectively govern Voice over Internet Protocol communication sessions, conferencing communication sessions, enterprise collaboration sessions, telehealth communication sessions, browser-based communication sessions, distributed communication sessions, accessibility communication sessions, interpreted speech sessions, synchronized caption sessions, or combinations thereof.

Communication authorization systems may process passenger-associated authorization credentials, seat-associated authorization credentials, communication authorization classifications, accessibility authorization classifications, conferencing authorization classifications, monetization classifications, subscription classifications, billing classifications, transportation-provider communication policies, operational transportation conditions, payment authorization conditions, cryptographic validation states, reauthorization intervals, or combinations thereof.

In certain embodiments, communication authorization systems may generate encrypted communication authorization tokens associated with passenger communication sessions. The encrypted communication authorization tokens may comprise passenger seat identifiers, passenger account identifiers, authorization timestamps, transportation-provider authorization classifications, accessibility communication classifications, monetization classifications, communication duration parameters, communication expiration parameters, session-renewal parameters, reauthorization parameters, cryptographic authentication parameters, or combinations thereof.

In certain embodiments, the communication authorization token may comprise a structured digital token generated by one or more communication authorization systems and cryptographically validated by one or more transportation-provider-managed communication governance systems. The communication authorization token may include one or more fields comprising a passenger identifier, passenger seat identifier, transportation-provider identifier, communication session identifier, authorization classification, accessibility classification, conferencing classification, monetization classification, issue timestamp, expiration timestamp, renewal interval, revocation state, cryptographic signature, nonce value, device association value, or combinations thereof. In certain embodiments, the communication authorization token may be generated as a signed token, encrypted token, certificate-backed token, time-limited session credential, or combinations thereof.

In certain embodiments, the communication authorization tokens and quality-of-service communication prioritization classifications described herein correspond to the communication authorization tokens, token fields, accessibility classifications, monetization classifications, and traffic priority classifications recited in one or more of claims. The token payload fields, expiration parameters, renewal intervals, accessibility flags, monetization flags, and policy classification values described in this Detailed Description may therefore be implemented using the structured digital token formats, traffic classification schemes, and bandwidth allocation mechanisms already discussed with respect to the Transportation Governance System 100, the Policy Engine 108, the QoS Classifier 808, the Bandwidth Allocator 1112, the Edge Node 1410, and the Cloud Synchronization Core 1412.

In certain embodiments, the communication authorization token may be bound to a specific passenger-operated portable electronic communication device, a specific passenger seat assignment, a specific transportation segment, a specific communication platform session, or combinations thereof. Binding the communication authorization token to both a passenger-associated credential and a seat-associated credential may reduce unauthorized token transfer, reduce circumvention of transportation-provider communication policies, and improve selective revocation accuracy. In certain embodiments, a communication session request presented from a device or seat inconsistent with the token binding may be denied, suspended, reauthorized, or logged for further review.

In certain embodiments, communication authorization tokens may expire after fixed durations, rolling time intervals, policy-defined event intervals, transportation-phase transitions, or combinations thereof. A communication authorization token may be revalidated periodically at predetermined intervals, including intervals of less than sixty seconds, less than thirty seconds, less than fifteen seconds, less than five seconds, substantially real-time intervals, or combinations thereof. In certain embodiments, expiration or failed revalidation may trigger session downgrade, bandwidth reduction, warning notification, temporary suspension, revocation, or termination of the associated communication session.

Transportation-provider-managed communication governance systems may selectively authorize communication sessions, synchronize communication sessions, prioritize communication sessions, meter communication sessions, monetize communication sessions, revoke communication sessions, suspend communication sessions, terminate communication sessions, dynamically allocate communication bandwidth resources, dynamically reallocate communication traffic priorities, reduce communication congestion, reduce communication latency, or restrict communication sessions.

In certain embodiments, policy enforcement may be performed at one or more distributed policy enforcement points positioned within the transportation-provider-managed communication infrastructure. The policy enforcement points may comprise one or more onboard routers, governance proxies, communication gateways, VoIP gateways, conferencing gateways, browser-based communication gateways, QoS classifiers, bandwidth allocators, edge-computing nodes, policy/AAA servers, cloud policy services, or combinations thereof. The policy enforcement points may validate the communication authorization token at session establishment, media-stream initiation, session renewal, platform transition, handoff between communication infrastructures, or detection of an operational transportation condition change.

In certain embodiments, session validation may comprise verifying token authenticity, checking expiration status, confirming seat association, confirming passenger identity association, evaluating current transportation-provider policy rules, checking monetization status, checking accessibility priority status, checking communication congestion conditions, checking operational transportation conditions, and determining whether the requested communication type is permitted. By distributing validation functions across onboard and remote policy enforcement points, the present disclosure may permit low-latency local enforcement while maintaining centralized policy consistency across a fleet or distributed transportation environment.

Operational transportation conditions may comprise aircraft altitude conditions, taxi operations, takeoff operations, climb operations, cruise operations, descent operations, turbulence conditions, emergency operations, operational transportation restrictions, transportation-provider communication policies, accessibility communication policies, communication congestion conditions, monetization conditions, bandwidth allocation conditions, communication latency conditions, or combinations thereof.

Accessibility communication rendering systems may facilitate communication accessibility for users having impaired speech, hearing impairments, visual impairments, articulation impairments, neurological communication impairments, degenerative communication impairments, communication-processing impairments, or combinations thereof.

Distributed speech rehabilitation processing systems may compare conditioned communication signals with stored user-associated speech data comprising speech samples associated with corresponding intelligible representations.

In certain embodiments, the stored user-associated speech data may comprise user-associated speech rehabilitation models, continuously updated speech samples, phonetic mappings, vocabulary mappings, machine-learning models, adaptive neural-network models, reinforcement-learning systems, probabilistic interpretation systems, confidence-scoring systems, continuously updated interpreted speech association systems, or combinations thereof.

In certain embodiments, distributed speech rehabilitation processing systems may continuously improve interpreted speech accuracy over time using updated user-associated speech samples and continuously updated speech rehabilitation mappings.

Synchronized multimodal communication rendering systems may generate synchronized interpreted speech outputs, synchronized caption outputs, synthesized speech outputs, regenerated speech outputs, textual outputs, browser-based communication outputs, conferencing outputs, enterprise collaboration outputs, telehealth outputs, accessibility communication outputs, multilingual accessibility outputs, synchronized multimodal communication outputs, or combinations thereof from interpreted communication representations.

In certain embodiments, synchronized multimodal communication rendering systems may synchronize interpreted speech outputs and synchronized caption outputs across heterogeneous communication endpoints comprising smartphones, browser-based communication systems, conferencing systems, telehealth systems, distributed cloud communication systems, passenger-operated communication devices, remote communication devices, transportation-provider communication terminals, or combinations thereof.

In certain embodiments, communication synchronization systems may maintain synchronization state records for one or more active communication sessions across onboard edge-computing infrastructures, cloud communication infrastructures, and remote endpoint systems. The synchronization state records may comprise token status, participant identity associations, seat associations, rendering preferences, accessibility profiles, interpreted representation timestamps, caption timing offsets, session sequence identifiers, congestion states, policy states, or combinations thereof. Synchronization events may be exchanged using push updates, pull requests, state-delta synchronization messages, event streams, replicated data stores, or combinations thereof.

In certain embodiments, when a communication session transitions between transportation environments, onboard access points, edge-computing nodes, conferencing platforms, or remote communication systems, one or more synchronization systems may reconcile session state using timestamps, sequence identifiers, conflict-resolution policies, or combinations thereof. A local edge-computing node may apply a current token validation state and current accessibility rendering configuration while a cloud synchronization core maintains persistent state continuity across multiple transportation segments or multiple transportation-provider-managed communication environments. This arrangement may reduce synchronization failures, improve continuity of accessibility rendering, and maintain policy-consistent session governance during network transitions.

Transportation-provider-managed communication governance systems may selectively govern communication sessions independently of whether passenger-operated communication devices comprise acoustic attenuation structures.

Transportation-provider-managed communication governance systems may selectively govern communication sessions independently of conferencing platform type, browser communication platform type, operating system type, communication endpoint type, communication application type, passenger-operated communication device manufacturer, Voice over Internet Protocol service provider, browser communication provider, conferencing provider, cloud communication provider, or combinations thereof.

Quality-of-service communication prioritization systems may dynamically prioritize conferencing communication traffic, Voice over Internet Protocol communication traffic, accessibility communication traffic, synchronized caption traffic, interpreted speech traffic, browser communication traffic, telehealth communication traffic, monetized communication traffic, or combinations thereof.

In certain embodiments, quality-of-service communication prioritization systems may dynamically allocate bandwidth resources according to communication priority classifications, transportation-provider operational policies, communication congestion conditions, accessibility classifications, passenger classifications, monetization classifications, or combinations thereof.

In certain embodiments, quality-of-service communication prioritization systems may implement packet-priority queues, communication traffic shaping systems, latency reduction systems, bandwidth reservation systems, differentiated communication traffic classifications, communication congestion mitigation systems, or combinations thereof.

In certain embodiments, quality-of-service communication prioritization systems may classify communication traffic into differentiated service classes associated with accessibility communication traffic, interpreted speech traffic, synchronized caption traffic, conferencing traffic, Voice over Internet Protocol traffic, telehealth traffic, browser communication traffic, monetized premium traffic, standard passenger traffic, restricted traffic, or combinations thereof. After classification, packets, frames, sessions, or communication streams may be assigned to one or more priority queues, weighted-fair queues, latency-sensitive queues, reserved-bandwidth queues, best-effort queues, or combinations thereof. Queue selection may be based on communication authorization token fields, transportation-provider policy rules, operational transportation conditions, monetization classifications, accessibility classifications, historical congestion data, or combinations thereof.

In certain embodiments, one or more bandwidth allocators may reserve minimum bandwidth for accessibility-rendering traffic and interpreted speech traffic while dynamically adjusting bandwidth ceilings for standard communication traffic during congestion conditions. The quality-of-service communication prioritization systems may implement weighted scheduling, traffic shaping, packet marking, differentiated-services enforcement, latency threshold monitoring, jitter threshold monitoring, admission control, or combinations thereof. This architecture may permit transportation-provider-managed communication infrastructures to preserve performance for accessibility-critical traffic and policy-authorized communication sessions while reducing congestion and limiting unauthorized or lower-priority traffic.

Communication monetization systems may support communication purchases, conferencing purchases, accessibility communication purchases, communication subscriptions, communication metering, authorization issuance, session-duration monetization systems, tokenized billing systems, distributed revenue allocation systems, or combinations thereof.

Communication logging systems may maintain communication authorization records, communication synchronization records, passenger seat records, timestamp records, accessibility communication records, synchronized caption records, interpreted speech records, browser communication records, conferencing records, monetization records, administrative override records, bandwidth allocation records, communication congestion records, or combinations thereof.

In certain embodiments, revocation events may be triggered by administrative override commands, emergency operational conditions, restricted transportation phases, policy-rule changes, payment failures, token expiration, seat reassignment, communication congestion thresholds, suspected misuse, accessibility-priority conflicts, or combinations thereof. One or more communication governance systems may propagate revocation instructions to one or more policy enforcement points, media gateways, conferencing systems, browser communication systems, and edge-computing nodes, thereby causing rapid blocking of media transport, session renegotiation failure, or forced session termination. Revocation and renewal events may be logged together with timestamps, associated policy states, and affected communication classifications.

Distributed cloud communication infrastructures may comprise airline-hosted server infrastructures, edge-computing infrastructures, distributed cloud-processing infrastructures, remote synchronization infrastructures, federated communication-processing systems, geographically distributed communication-processing systems, or combinations thereof.

In certain embodiments, edge-computing infrastructures positioned onboard a transportation vehicle may perform low-latency functions comprising token validation, packet classification, queue assignment, speech conditioning, interpreted speech preprocessing, caption timing alignment, local accessibility rendering, temporary audit caching, emergency revocation enforcement, or combinations thereof. Cloud communication infrastructures may perform higher-compute or cross-session functions comprising fleet-wide policy distribution, user-associated speech model management, cross-vehicle synchronization, large-scale audit retention, conferencing coordination, caption service processing, monetization reconciliation, or combinations thereof. One or more communication sessions may therefore be governed using a cooperative processing model in which latency-sensitive enforcement occurs at the onboard edge while persistent coordination and cross-environment synchronization occur through cloud-hosted services.

In certain embodiments, if connectivity between an onboard edge-computing node and a cloud communication service is degraded or unavailable, the onboard edge-computing node may continue enforcing a local policy subset, local token validity rules, local queueing rules, and local accessibility-rendering rules for a predetermined interval. Upon restoration of connectivity, the onboard edge-computing node may synchronize locally cached audit events, session state updates, token revocation events, rendering events, and bandwidth allocation records with the cloud communication service. This architecture may improve continuity of governed communication services in intermittent-connectivity transportation environments.

Transportation-provider-managed communication environments may comprise aircraft environments, train environments, rail transportation environments, bus environments, maritime transportation environments, transportation hubs, passenger terminals, distributed transportation systems, fleet transportation systems, or combinations thereof.

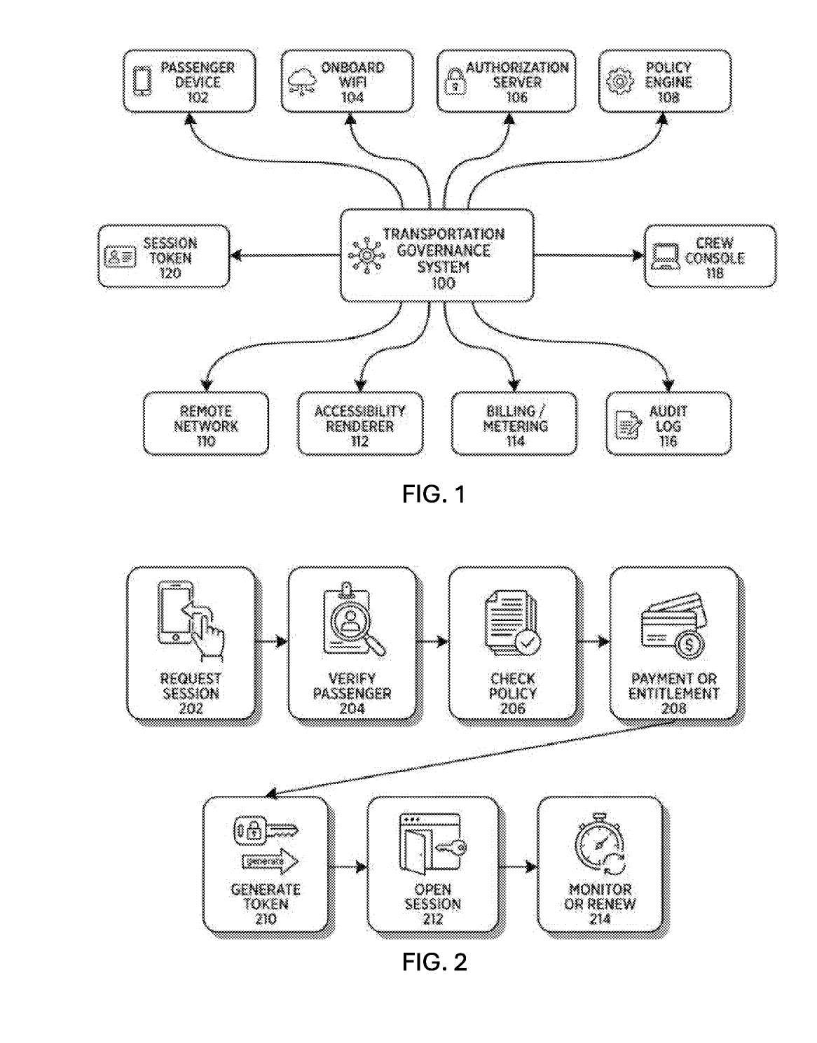

FIG. 1 – Transportation-Provider-Managed Communication Governance Ecosystem

FIG. 1 is a block diagram depicting the top-level architecture of the transportation-provider-managed communication governance ecosystem 100. At the center of the diagram is a large rectangular block labeled "Transportation Governance System 100," which serves as the governing hub connecting all other components. Radiating outward from this central block are eight peripheral components arranged around its perimeter. To the upper left is a block labeled "Passenger Device 102," representing a passenger-operated portable electronic communication device. To the upper center is a block labeled "Onboard WiFi 104," representing the onboard wireless communication network through which passenger devices access the governance system. To the upper right is a block labeled "Authorization Server 106," representing the server responsible for authenticating passengers and issuing communication authorization tokens. To the right is a block labeled "Policy Engine 108," representing the system that enforces transportation-provider communication policies. To the lower right is a block labeled "Remote Network 110," representing the external communication network through which passenger sessions route to remote parties. To the lower center is a block labeled "Accessibility Renderer 112," representing the accessibility communication rendering system. To the lower left is a block labeled "Billing/Metering 114," representing the communication monetization and metering system. To the left is a block labeled "Audit Log 116," representing the communication logging and compliance infrastructure. To the upper left, adjacent to the Passenger Device block, is a block labeled "Crew Console 118," representing the transportation-provider administrative override interface. Finally, a block labeled "Session Token 120" appears near the Authorization Server, representing the communication authorization token generated upon successful passenger authorization.

In use, a passenger initiates a communication request from Passenger Device 102, which connects through Onboard WiFi 104 to the Transportation Governance System 100. The Authorization Server 106 processes the passenger’s authorization credentials and, upon verification against Policy Engine 108, generates a Session Token 120 associated with the passenger’s identity, seat assignment, communication classification, and applicable policies. The Transportation Governance System 100 then establishes the communication session through Remote Network 110, while simultaneously monitoring the session for compliance with transportation-provider policies, delegating accessibility rendering to Accessibility Renderer 112, recording metering data in Billing/Metering 114, and logging session events in Audit Log 116. The Crew Console 118 provides authorized transportation-provider operators with the ability to monitor, modify, or terminate active sessions in substantially real time.

FIG. 2 – Passenger Communication Authorization and Token Workflow

FIG. 2 is a flow diagram depicting the sequential steps of the passenger communication authorization and token workflow. The diagram presents seven rectangular process blocks arranged vertically from top to bottom, connected by downward-pointing arrows indicating sequential flow. The first block at the top is labeled "Request Session 202," representing the passenger-initiated communication request. Below it is a block labeled "Verify Passenger 204," representing the authentication of the passenger’s identity and authorization credentials. Below that is a block labeled "Check Policy 206," representing the evaluation of the passenger’s request against applicable transportation-provider communication policies. Below that is a block labeled "Payment or Entitlement 208," representing the determination of whether the passenger has satisfied applicable payment or subscription entitlement requirements. Below that is a block labeled "Generate Token 210," representing the issuance of a cryptographically validated communication authorization token upon successful policy and payment verification. Below that is a block labeled "Open Session 212," representing the establishment of the communication session using the generated token. The final block at the bottom is labeled "Monitor or Renew 214," representing the ongoing monitoring of the active session for policy compliance, token validity, and the optional renewal of the token upon expiration.

In use, a passenger initiates a communication request (202), triggering verification of the passenger’s identity and credentials (204). The governance system evaluates the request against applicable transportation-provider policies (206) and confirms payment or entitlement status (208). Upon successful verification, the system generates an encrypted communication authorization token (210) and uses that token to open the communication session (212). Throughout the duration of the session, the governance system monitors the session for continued token validity, policy compliance, and congestion conditions, and may prompt token renewal upon approaching expiration (214). The entire authorization sequence may be completed within a time interval that provides substantially seamless session establishment from the passenger’s perspective.

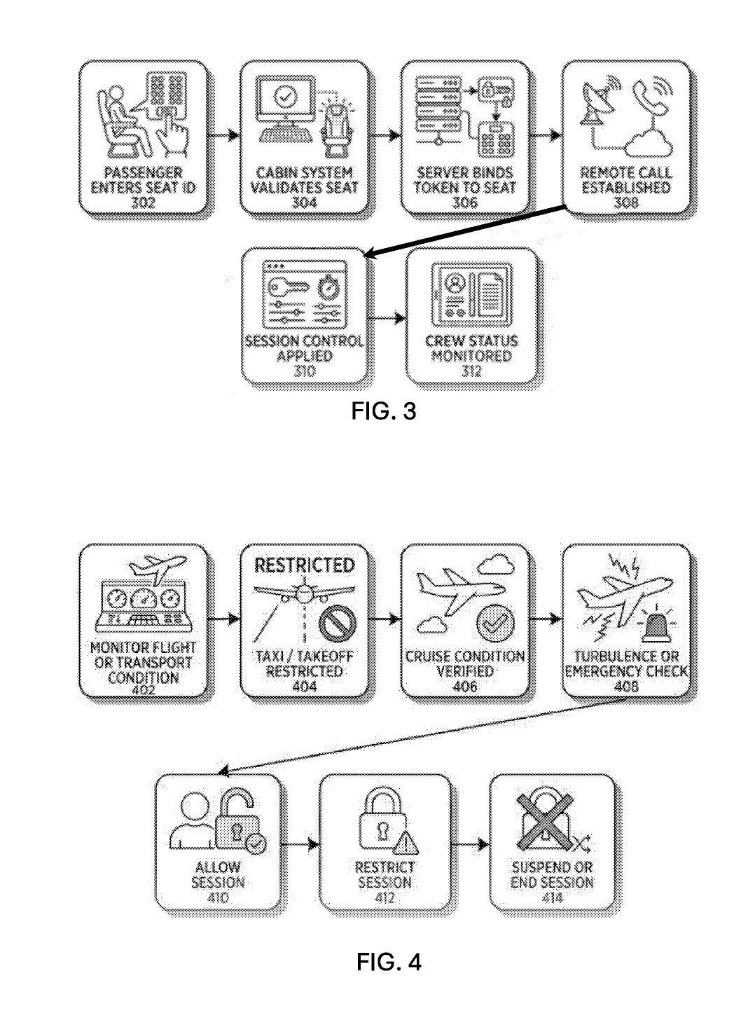

FIG. 3 – Seat-Associated Authorization and Session Control Workflow

FIG. 3 is a flow diagram depicting the seat-associated authorization and session control workflow. The diagram presents six rectangular process blocks arranged vertically from top to bottom, connected by downward-pointing arrows. The first block is labeled "Passenger Enters Seat ID 302," representing the step in which the passenger provides their seat identifier as part of the authorization process. The second block is labeled "Cabin System Validates Seat 304," representing the validation of the entered seat identifier against cabin configuration data. The third block is labeled "Server Binds Token to Seat 306," representing the association of the generated communication authorization token with the specific seat identifier and the passenger authorized at that seat. The fourth block is labeled "Remote Call Established 308," representing the establishment of a remote communication session authorized under the seat-bound token. The fifth block is labeled "Session Control Applied 310," representing the application of transportation-provider session controls—including quality-of-service parameters, communication restrictions, and operational condition governance—to the established session. The final block is labeled "Crew Status Monitored 312," representing the ongoing monitoring of the session by crew or administrative systems for compliance with transportation-provider policies.

In use, when a passenger initiates a communication session, the passenger provides a seat identifier (302) that the cabin system validates against seat configuration records (304). The authorization server then binds the issued communication authorization token to the validated seat identifier (306), associating all session governance with the specific passenger location within the transportation vehicle. The token-bound session is established as a remote call (308), and session control parameters—including applicable quality-of-service classifications, communication restrictions, and operational transportation condition governance—are applied to the session (310). Crew and administrative systems monitor the session status continuously (312), enabling rapid response to operational transportation condition changes, passenger compliance issues, or administrative override requirements.

FIG. 4 – Operational Transportation Condition Governance Workflow

FIG. 4 is a flow diagram depicting the operational transportation condition governance workflow. The diagram presents seven rectangular process blocks. The first block at the top is labeled "Monitor Flight or Transport Condition 402," representing the continuous monitoring of operational transportation conditions by the governance system. The second block is labeled "Restricted Taxi/Takeoff Restricted 404," representing the detection of restricted operational conditions such as taxi operations or takeoff phases. The third block is labeled "Cruise Condition Verified 406," representing the detection of permissive operational conditions such as cruise altitude. The fourth block is labeled "Turbulence or Emergency Check 408," representing the detection of turbulence conditions or emergency operational conditions. The fifth block, branching to the right, is labeled "Allow Session 410," representing the governance outcome of permitting communication sessions when operational conditions are permissive. The sixth block, branching to the left, is labeled "Restrict Session 412," representing the governance outcome of restricting communication sessions when operational conditions impose restrictions. The final block, below the restriction branch, is labeled "Suspend or End Session 414," representing the governance outcome of suspending or terminating active communication sessions in response to emergency or prohibited operational conditions.

In use, the Transportation Governance System 100 continuously monitors operational transportation conditions (402) received from the vehicle’s operational systems, including flight management systems in aircraft environments. When restricted conditions are detected—such as taxi operations or takeoff phase (404)—the governance system restricts or prevents initiation of new communication sessions (412) and may suspend or terminate active sessions (414) in accordance with transportation-provider policies. When cruise conditions are verified (406), the governance system permits communication sessions within policy parameters (410). Upon detection of turbulence or emergency conditions (408), the governance system may rapidly suspend or terminate active sessions (414) to comply with safety requirements and operational policies. This architecture enables the present disclosure to address a significant deficiency in prior art systems—including the binary device-disablement approach of U.S. Patent No. 10,044,842—by providing granular, condition-responsive communication governance that operates continuously and dynamically across the full range of transportation operational phases.

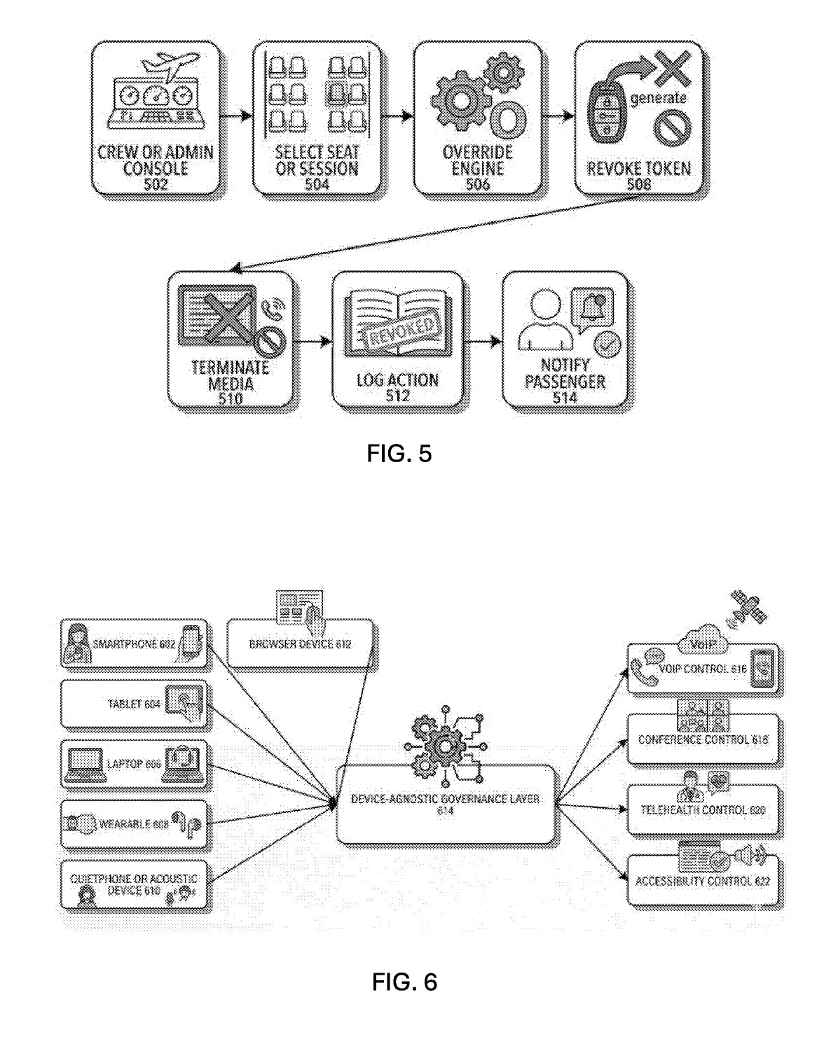

FIG. 5 – Administrative Override and Session Revocation Workflow

FIG. 5 is a flow diagram depicting the administrative override and session revocation workflow. The diagram presents seven rectangular process blocks arranged vertically from top to bottom, connected by downward-pointing arrows. The first block at the top is labeled "Crew or Admin Console 502," representing the transportation-provider administrative override interface through which authorized crew or administrative personnel initiate override actions. The second block is labeled "Select Seat or Session 504," representing the administrator’s selection of a specific passenger seat or active communication session for override action. The third block is labeled "Override Engine 506," representing the processing system that executes administrative override commands. The fourth block is labeled "Revoke Token 508," representing the revocation of the communication authorization token associated with the selected session. The fifth block is labeled "Terminate Media 510," representing the termination of active media streams associated with the revoked session. The sixth block is labeled "Log Action 512," representing the recording of the administrative override action in the audit log infrastructure. The final block at the bottom is labeled "Notify Passenger 514," representing the delivery of a notification to the affected passenger regarding the session termination.

In use, an authorized crew member or administrator accesses the Crew or Admin Console 502 and selects the specific passenger seat or communication session to be overridden (504). The Override Engine 506 processes the override command and revokes the communication authorization token associated with the targeted session (508), causing active media streams to terminate (510). The administrative override action is recorded in the audit log (512) to maintain a complete compliance record, and the affected passenger receives notification of the session termination (514). The administrative override sequence may be completed within predetermined time intervals comprising less than thirty seconds, less than ten seconds, less than five seconds, or substantially real-time intervals, enabling rapid response to safety-critical operational conditions. This architecture distinguishes the present disclosure from prior art systems, including U.S. Patent No. 10,044,842, which provides only a binary device-level disable mechanism without the granular session-level override, logging, and passenger notification capabilities of the present disclosure.

FIG. 6 – Device-Agnostic Passenger Communication Governance Architecture

FIG. 6 is a block diagram depicting the device-agnostic passenger communication governance architecture. On the left side of the diagram, five blocks arranged vertically represent different types of passenger-operated portable electronic communication devices: "Smartphone 602" at the top, "Tablet 604" below it, "Laptop 606" below that, "Wearable 608" below that, and "Quietphone or Acoustic Device 610" at the bottom. Across from the device list, and separated by a central vertical bar representing the "Device-Agnostic Governance Layer 614," are four blocks representing the governance control subsystems: "VoIP Control 616" at the top, "Conference Control 618" below it, "Telehealth Control 620" below that, and "Accessibility Control 622" at the bottom. Additionally, on the far left of the diagram, a block labeled "Browser Device 612" is positioned adjacent to the device column, representing browser-based communication devices as an additional category of governed endpoint.

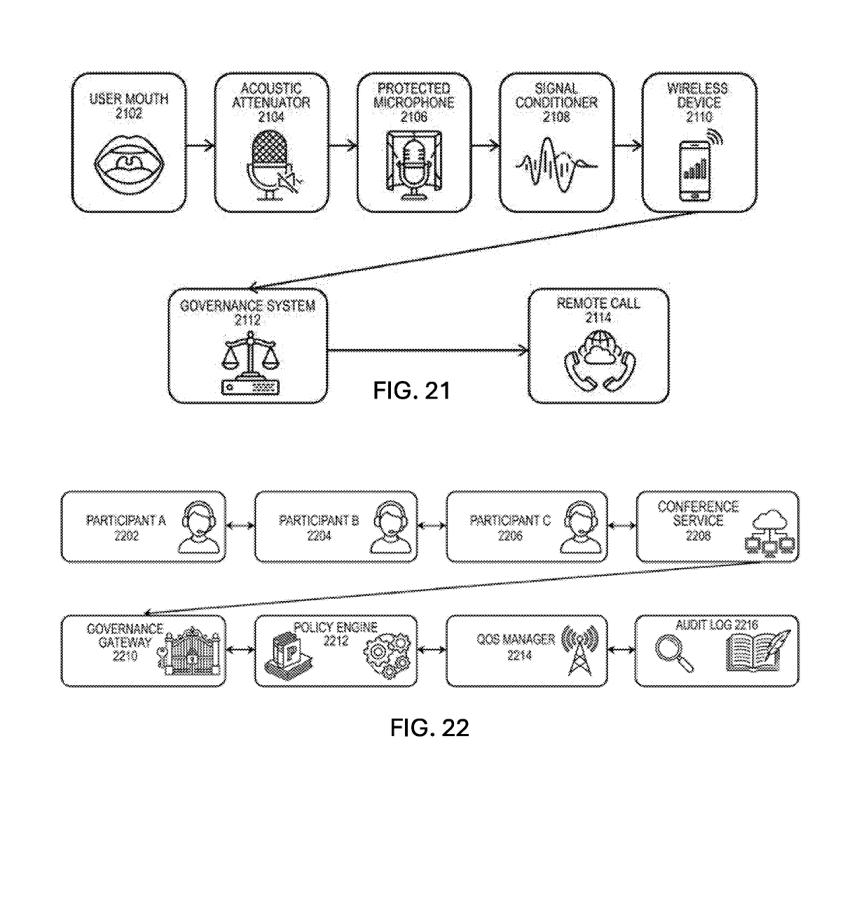

In use, the Device-Agnostic Governance Layer 614 operates as an abstraction layer between the heterogeneous population of passenger-operated communication devices—including smartphones (602), tablets (604), laptops (606), wearables (608), Quietphone or acoustic attenuation devices (610), and browser-based devices (612)—and the communication governance control subsystems. Regardless of the device type, operating system, or communication platform employed by the passenger, the Device-Agnostic Governance Layer 614 applies consistent transportation-provider communication governance through VoIP Control 616, Conference Control 618, Telehealth Control 620, and Accessibility Control 622. This architecture enables the present disclosure to govern communication sessions independently of device manufacturer, conferencing provider, browser platform type, or operating system type—a capability absent from prior art systems including U.S. Patent Nos. 10,460,730 and 10,044,842, which are limited to specific device or announcement types. The Quietphone or Acoustic Device 610 represents an optional hardware interface for users requiring acoustic attenuation during speech acquisition, as further described in connection with FIG. 21 and in the parent application, U.S. Patent Application Serial No. 19/287,882.

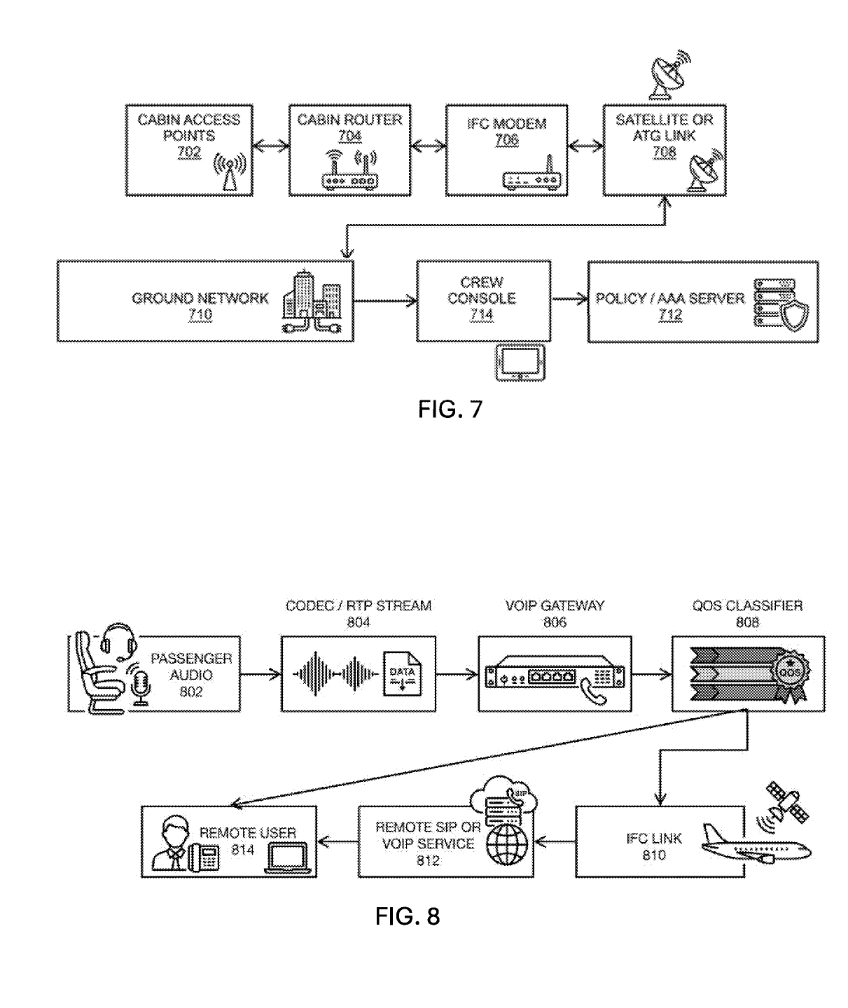

FIG. 7 – Onboard Wireless Communication Infrastructure

FIG. 7 is a block diagram depicting the onboard wireless communication infrastructure. The diagram presents a layered, top-to-bottom architecture representing the communication pathway from passenger devices to the ground network. At the top are "Cabin Access Points 702," representing the wireless access points distributed throughout the transportation vehicle cabin that provide wireless connectivity to passenger-operated communication devices. Below the cabin access points is "Cabin Router 704," representing the onboard routing system that aggregates wireless traffic from the cabin access points and manages communication traffic within the vehicle’s internal network. Below the cabin router is "IFC Modem 706," representing the in-flight connectivity modem that interfaces the onboard network with the external communication link. Below the IFC modem is "Satellite or ATG Link 708," representing the satellite communication system or air-to-ground communication link that provides the physical connection between the onboard communication infrastructure and the ground network. At the bottom is "Ground Network 710," representing the terrestrial internet and communication network accessed through the satellite or air-to-ground link. To the side of this main infrastructure stack is "Policy/AAA Server 712," representing the authentication, authorization, and accounting server that enforces transportation-provider communication policies and manages communication session authorization. Also shown is "Crew Console 714," representing the crew’s interface to the onboard communication infrastructure for monitoring and administrative purposes.

In use, passenger-operated communication devices connect wirelessly to Cabin Access Points 702, which route communication traffic through Cabin Router 704. The Cabin Router 704 applies traffic classification and initial governance checks in coordination with Policy/AAA Server 712 before forwarding authorized traffic to IFC Modem 706. The IFC Modem 706 transmits outbound communication sessions through Satellite or ATG Link 708 to Ground Network 710, and receives inbound communication traffic through the same link. Policy/AAA Server 712 enforces communication authorization token validation, quality-of-service classifications, and bandwidth allocation parameters at the network layer. Crew Console 714 provides the transportation-provider operator with visibility into active sessions, infrastructure status, and the capability to initiate administrative override actions. This architecture provides the physical communication infrastructure foundation upon which the transportation-provider-managed communication governance systems of the present disclosure operate.

FIG. 8 – Voice over Internet Protocol Communication Routing Architecture

FIG. 8 is a block diagram depicting the Voice over Internet Protocol communication routing architecture. On the left side of the diagram, a block labeled "Passenger Audio 802" represents the audio input from a passenger-operated communication device. To the right of the passenger audio block is a block labeled "Codec/RTP Stream 804," representing the audio codec and Real-time Transport Protocol stream that encodes and packetizes the passenger’s voice for transmission. To the right of the codec block is a block labeled "VoIP Gateway 806," representing the voice-over-internet-protocol gateway that routes the encoded voice session. Below the VoIP gateway is a block labeled "QoS Classifier 808," representing the quality-of-service classifier that assigns priority classifications to the voice session traffic. To the right of the QoS classifier is a block labeled "IFC Link 810," representing the in-flight connectivity link through which the voice session is routed to the remote network. At the far right of the diagram are two blocks: "Remote SIP or VoIP Service 812," representing the remote session initiation protocol or VoIP service with which the passenger is communicating, and "Remote User 814," representing the remote communication party on the other end of the session. Arrows indicating data flow and a label for "SIP" signaling indicate the session initiation protocol pathway between the VoIP Gateway 806 and Remote SIP or VoIP Service 812.

In use, the passenger’s voice is captured at Passenger Audio 802 and encoded into a Codec/RTP Stream 804 for packetized transmission. The encoded stream is routed through VoIP Gateway 806, which applies session initiation protocol signaling to establish, maintain, and terminate the voice session. QoS Classifier 808 assigns the voice session an appropriate quality-of-service priority classification—elevating accessibility-classified voice sessions above standard data traffic and subordinating unpaid or unauthorized traffic—before the stream is forwarded over IFC Link 810 to Remote SIP or VoIP Service 812 and ultimately to Remote User 814. The quality-of-service classification applied at QoS Classifier 808 is governed by the communication authorization token and transportation-provider policies enforced by the Transportation Governance System 100, ensuring that VoIP communication sessions operate within the bandwidth and latency parameters authorized for the specific passenger and session classification.

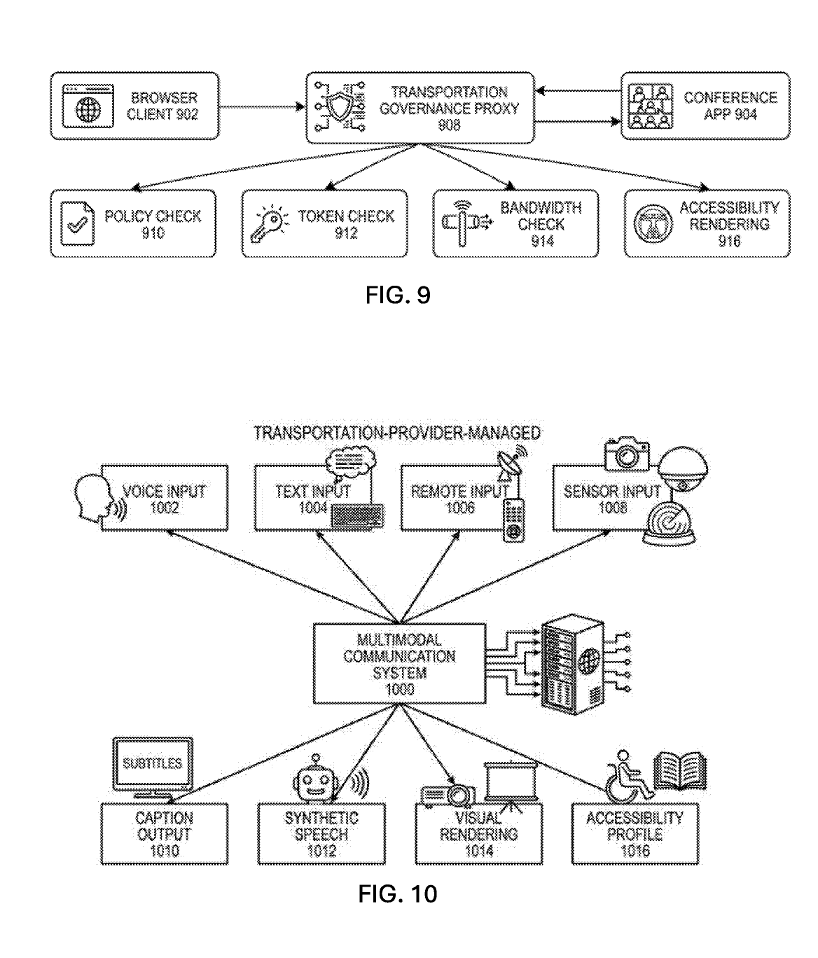

FIG. 9 – Browser-Based Conferencing, Enterprise Collaboration, and Telehealth Communication Governance Architecture

FIG. 9 is a block diagram depicting the browser-based conferencing, enterprise collaboration, and telehealth communication governance architecture. On the left side of the diagram are two blocks representing passenger-side communication interfaces: "Browser Client 902" at the upper left, representing a browser-based communication application operating on a passenger device, and "Conference App 904" below it, representing a dedicated conferencing or collaboration application. In the center of the diagram is a large block labeled "Transportation Governance Proxy 908," representing the governance proxy through which all browser and conference communication sessions are routed and governed. Within or adjacent to the Transportation Governance Proxy 908, three sub-process blocks are shown: "Policy Check 910," representing the evaluation of the session against transportation-provider communication policies; "Token Check 912," representing the validation of the passenger’s communication authorization token; and "Bandwidth Check 914," representing the evaluation of available bandwidth and applicable quality-of-service parameters. To the right of the proxy is a block labeled "Accessibility Rendering 916," representing the accessibility communication rendering subsystem that processes the governed session output for delivery to passengers with communication disabilities.

In use, browser-based communication sessions initiated from Browser Client 902 and conferencing sessions initiated from Conference App 904 are routed through Transportation Governance Proxy 908. The proxy performs Policy Check 910 to verify that the session is permissible under current transportation-provider policies and operational transportation conditions, Token Check 912 to validate the passenger’s communication authorization token, and Bandwidth Check 914 to confirm that sufficient bandwidth is available within applicable quality-of-service parameters. Sessions that pass all governance checks are routed to their destinations while Accessibility Rendering 916 processes the session content to generate synchronized interpreted speech outputs, synchronized caption outputs, or other accessibility communication outputs for passengers with communication disabilities. This architecture distinguishes the present disclosure from prior art browser-based and conferencing systems that lack transportation-provider-managed governance proxy capabilities, and from the prior art announcement and device-disablement systems of Airbus’s U.S. Patent No. 10,460,730 and U.S. Patent Application Publication No. 2025/0273197, which do not govern individual passenger-initiated bidirectional communication sessions.

FIG. 10 – Transportation-Provider-Managed Multimodal Communication System

FIG. 10 is a block diagram depicting the transportation-provider-managed multimodal communication system 1000. In the center of the diagram is a large block labeled "Multimodal Communication System 1000," representing the central multimodal processing hub managed by the transportation provider. This block is labeled "Transportation-Provider-Managed" at the top. Feeding into the left side of the central block are four input blocks arranged vertically: "Voice Input 1002" at the top, representing voice communication signals; "Text Input 1004" below it, representing text-based communication inputs; "Remote Input 1006" below that, representing inputs received from remote communication parties; and "Sensor Input 1008" at the bottom, representing data inputs from onboard sensors. Emanating from the right side of the central block are four output blocks arranged vertically: "Subtitles/Caption Output 1010" at the top, representing synchronized caption outputs; "Synthetic Speech 1012" below it, representing synthesized or regenerated speech outputs; "Visual Rendering 1014" below that, representing visual communication rendering outputs; and "Accessibility Profile 1016" at the bottom, representing the passenger-specific accessibility rendering profile that governs output formatting.

In use, the Multimodal Communication System 1000 receives communication inputs from multiple sources—including voice (1002), text (1004), remote (1006), and sensor (1008) inputs—and processes them according to transportation-provider governance parameters and passenger-specific Accessibility Profile 1016. The system generates multiple synchronized output streams: Subtitles/Caption Output 1010 for hearing-impaired passengers, Synthetic Speech 1012 for passengers with visual impairments or those using speech rehabilitation services, and Visual Rendering 1014 for passengers requiring visual accessibility rendering. The Accessibility Profile 1016 enables the multimodal system to adapt its output rendering configuration for individual passengers based on their documented communication disability classifications, preferred rendering modes, and language preferences. This architecture directly addresses the deficiency identified in the background of the present disclosure—that existing transportation communication systems fail to provide synchronized multimodal accessibility rendering infrastructures—and is distinguished from the one-way passenger announcement transcription approach of Airbus’s U.S. Patent Application Publication No. 2025/0273197 by its bidirectional, multimodal, passenger-specific accessibility governance capabilities.

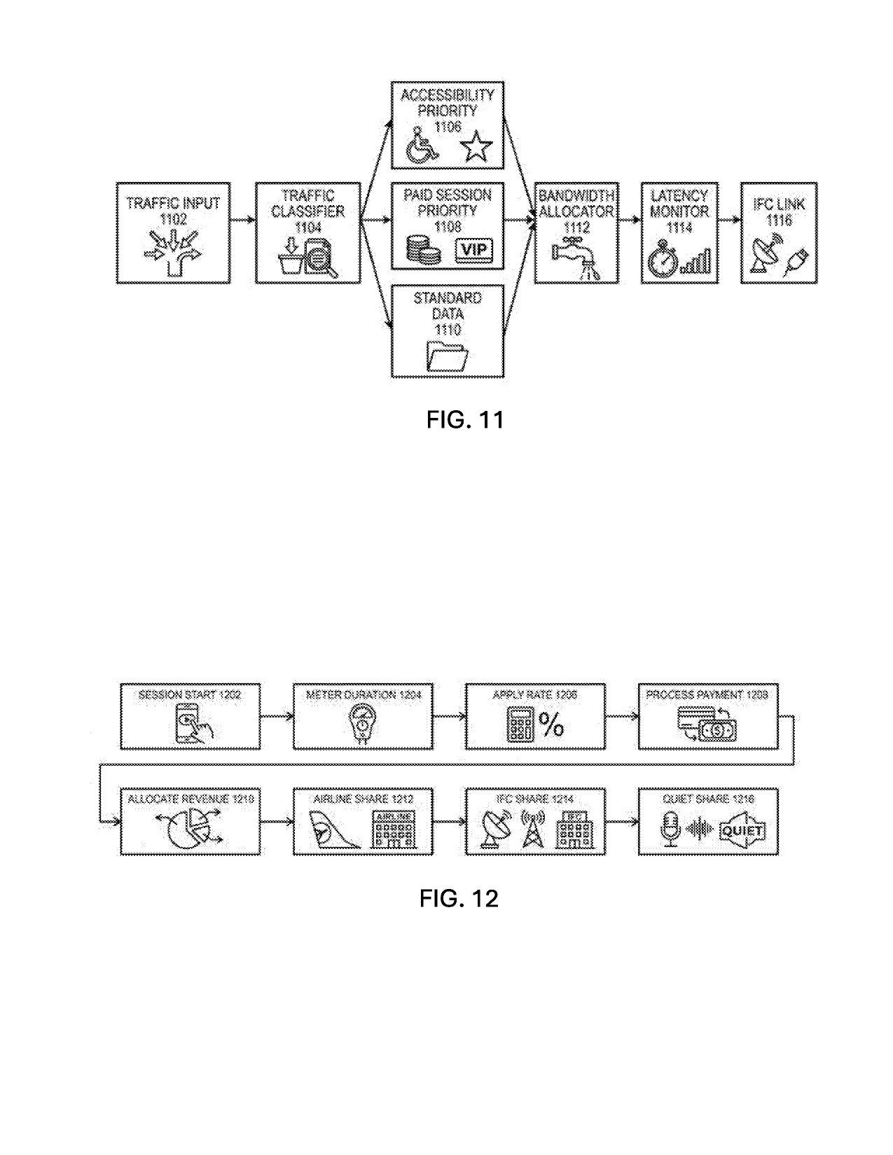

FIG. 11 – Quality-of-Service Prioritization, Latency Control, and Bandwidth Allocation Architecture

FIG. 11 is a block diagram depicting the quality-of-service prioritization, latency control, and bandwidth allocation architecture. On the far left is a block labeled "Traffic Input 1102," representing the incoming communication traffic from all passenger sessions. To the right of the traffic input is a block labeled "Traffic Classifier 1104," representing the system that evaluates incoming traffic and assigns traffic classification categories based on session type, passenger authorization class, and applicable policies. To the right of the traffic classifier are three priority-tier blocks arranged vertically: "Accessibility Priority 1106" at the top—flagged as the highest priority tier—representing accessibility-classified communication traffic including interpreted speech, synchronized captions, and accessibility rendering sessions; "Paid Session Priority 1108" in the middle—labeled "VIP"—representing communication sessions associated with premium or paid communication authorizations; and "Standard Data 1110" at the bottom, representing standard-priority communication data not classified as accessibility or premium traffic. To the right of the priority tiers is a block labeled "Bandwidth Allocator 1112," representing the system that dynamically allocates available bandwidth according to the traffic priority classifications. Below the bandwidth allocator is a block labeled "Latency Monitor 1114," representing the system that monitors communication latency across active sessions. At the far right is a block labeled "IFC Link 1116," representing the in-flight connectivity link through which the prioritized, bandwidth-allocated traffic is transmitted.

In use, incoming communication traffic from all active passenger sessions enters through Traffic Input 1102 and is classified by Traffic Classifier 1104 according to session type and passenger authorization classification. Accessibility-classified traffic—including interpreted speech sessions, synchronized caption streams, and accessibility rendering outputs—is assigned Accessibility Priority 1106 and receives the highest bandwidth reservation and lowest latency allocation. Paid and premium sessions receive Paid Session Priority 1108, with bandwidth allocation commensurate with their purchased communication tier. Standard data traffic is classified as Standard Data 1110 and receives remaining bandwidth allocations after higher-priority traffic has been served. Bandwidth Allocator 1112 dynamically adjusts bandwidth allocations across all active sessions in response to real-time congestion conditions, operational transportation condition changes, and token authorization parameters. Latency Monitor 1114 continuously tracks session latency and triggers dynamic reallocation when latency thresholds are exceeded. The bandwidth-managed, prioritized traffic is then transmitted through IFC Link 1116. This architecture is distinguished from the general-purpose bandwidth allocation approaches of U.S. Patent No. 6,272,140 and EP 1 851 919 A1 by its transportation-environment-specific prioritization of accessibility communication traffic and its integration with the transportation-provider communication authorization token and governance systems of the present disclosure.

FIG. 12 – Monetization, Metering, Billing, and Revenue Allocation Workflow

FIG. 12 is a flow diagram depicting the monetization, metering, billing, and revenue allocation workflow. At the top of the diagram is a block labeled "Session Start 1202," representing the initiation of a metered communication session. Below it is a block labeled "Meter Duration 1204," representing the real-time metering of session duration against applicable billing parameters. Below that is a block labeled "Apply Rate 1206"—accompanied by a percentage symbol indicating rate-based billing—representing the application of the applicable communication rate or tariff to the metered session duration. Below the rate application block is a block labeled "Process Payment 1208," representing the processing of payment or deduction from the passenger’s communication account. Below the payment block is a block labeled "Allocate Revenue 1210," representing the distribution of collected revenue among applicable parties. Below the revenue allocation block are three subordinate blocks arranged horizontally: "Airline Share 1212"—labeled "AIRLINE"—representing the portion of revenue allocated to the transportation provider; "IFC Share 1214"—labeled "IFC"—representing the portion allocated to the in-flight connectivity provider; and "Quiet Share 1216"—labeled "QUIET"—representing the portion allocated to Quiet, Inc. as the governance and accessibility system provider.

In use, when a passenger initiates a metered communication session, Session Start 1202 triggers the commencement of metering. Meter Duration 1204 tracks the real-time duration of the session against the billing parameters encoded in the passenger’s communication authorization token. Apply Rate 1206 calculates the applicable communication charge based on the session duration and applicable rate tier—which may reflect standard, premium, or accessibility-classified pricing—and Process Payment 1208 executes the charge against the passenger’s stored payment method or communication account. Upon session conclusion or billing period completion, Allocate Revenue 1210 distributes the collected revenue among the transportation provider (Airline Share 1212), the in-flight connectivity provider (IFC Share 1214), and the governance and accessibility system provider (Quiet Share 1216) according to pre-configured revenue sharing agreements. This architecture provides an integrated tokenized billing and distributed revenue allocation system that is absent from the prior art cabin communication and device-governance systems identified in the background of the present disclosure.

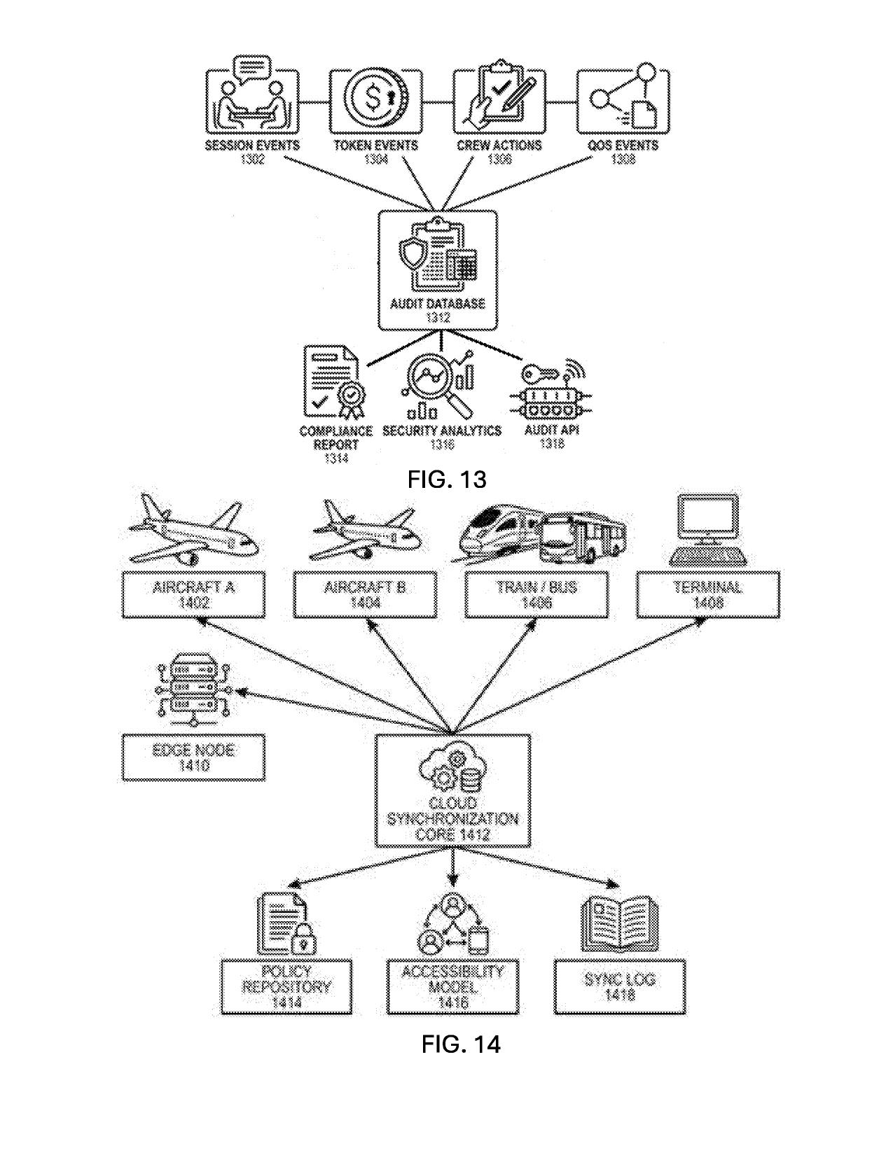

FIG. 13 – Communication Logging and Audit Infrastructure

FIG. 13 is a block diagram depicting the communication logging and audit infrastructure. On the left side of the diagram are four input blocks arranged vertically, representing categories of events captured by the audit infrastructure: "Session Events 1302" at the top, representing records of communication session initiation, modification, and termination events; "Token Events 1304" below it, representing records of communication authorization token issuance, renewal, and revocation events; "Crew Actions 1306" below that, representing records of administrative override actions taken by crew or administrative personnel; and "QoS Events 1308" at the bottom, representing records of quality-of-service classification changes, bandwidth allocation adjustments, and congestion events. In the center of the diagram is a block labeled "Audit Database 1312," representing the persistent database in which all logged events are stored. To the right of the audit database are three output blocks arranged vertically: "Compliance Report 1314" at the top, representing automated compliance reports generated from audit records; "Security Analytics 1316" in the middle, representing security analysis functions applied to audit data; and "Audit API 1318" at the bottom, representing an application programming interface that provides authorized parties with access to audit records.

In use, all session events (1302), token events (1304), crew administrative actions (1306), and quality-of-service events (1308) are captured and stored in Audit Database 1312 in real time as they occur. The audit infrastructure maintains a complete, timestamped, immutable record of all governance actions, authorization events, and session activities, providing the transportation provider with the data necessary to generate Compliance Reports 1314 for regulatory and operational review, to conduct Security Analytics 1316 for detection of unauthorized access attempts or policy circumvention, and to provide authorized parties with programmatic access to audit records through Audit API 1318. This comprehensive audit capability—absent from prior art cabin communication and device-governance systems including U.S. Patent No. 10,044,842 and U.S. Patent No. 10,460,730—supports the transportation provider’s operational compliance obligations and provides a verifiable record of all communication governance actions.

FIG. 14 – Distributed Transportation Communication Environment Synchronization Architecture

FIG. 14 is a block diagram depicting the distributed transportation communication environment synchronization architecture. On the left side of the diagram are four blocks arranged vertically, each representing a distinct transportation environment node: "Aircraft A 1402" and "Aircraft B 1404" at the top, representing two separate aircraft operating as independent transportation communication environments; "Train/Bus 1406" below them, representing rail or bus transportation environments; and "Terminal 1408" at the bottom, representing a passenger terminal environment such as an airport gate or transit hub. To the right of the transportation environment nodes, and connected to them by horizontal arrows indicating bidirectional data flow, is a block labeled "Edge Node 1410," representing the distributed edge-computing node that processes and synchronizes communication governance data proximate to each transportation environment. To the right of the edge node, and connected to it by bidirectional arrows, is a large block labeled "Cloud Synchronization Core 1412," representing the central cloud infrastructure that maintains synchronized governance state across all connected transportation environment nodes. Within the Cloud Synchronization Core 1412, three subordinate blocks are shown: "Policy Repository 1414," representing the centralized repository of transportation-provider communication policies; "Accessibility Model 1416," representing the centralized repository of passenger accessibility profiles and speech rehabilitation models; and "Sync Log 1418," representing the synchronization event log maintained by the cloud core.

In use, each transportation environment node—whether Aircraft A (1402), Aircraft B (1404), Train/Bus (1406), or Terminal (1408)—maintains communication governance through its associated Edge Node 1410, which provides low-latency governance processing proximate to the passenger communication environment. The Edge Node 1410 synchronizes governance state, passenger accessibility profiles, communication authorization token status, and policy updates with the Cloud Synchronization Core 1412. The Cloud Synchronization Core 1412 maintains the authoritative Policy Repository 1414, ensuring that consistent transportation-provider communication policies are enforced across all transportation environments, and the Accessibility Model 1416, ensuring that passenger speech rehabilitation models and accessibility profiles are available across all environments a passenger may transit. The Sync Log 1418 provides a complete record of all synchronization events for compliance and diagnostic purposes. This architecture enables the seamless portability of passenger communication authorization and accessibility services across heterogeneous transportation environments—a capability absent from the fixed-environment, single-vehicle communication governance approaches of the prior art.

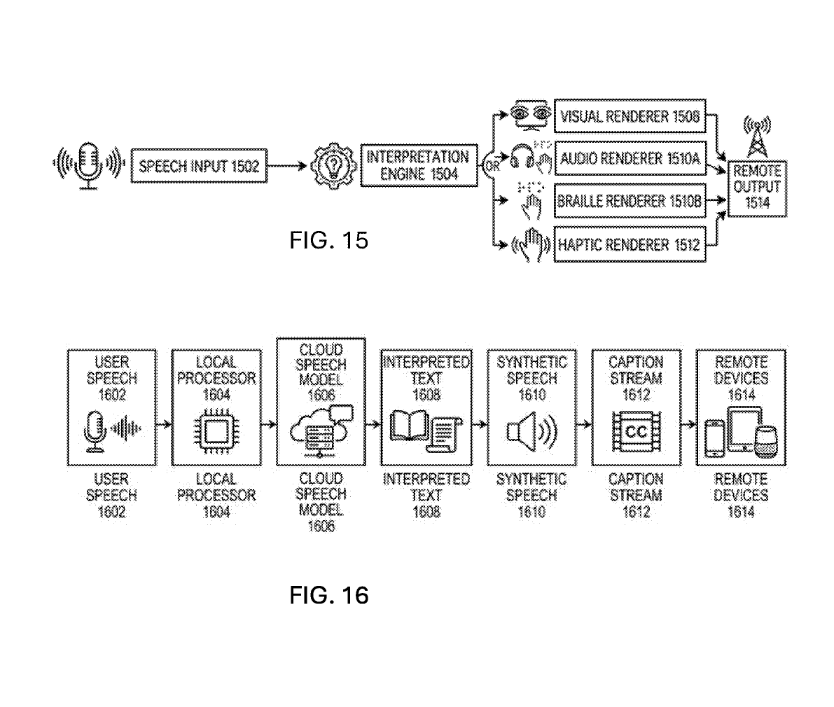

FIG. 15 – Accessibility Communication Rendering Architecture

FIG. 15 is a block diagram depicting the accessibility communication rendering architecture. At the top left of the diagram is a block labeled "Speech Input 1502," representing an audio speech signal received from a passenger’s communication session. To the right of the speech input is a block labeled "Interpretation Engine 1504," representing the system that processes the speech input to generate an interpreted representation. Below the interpretation engine, branching into multiple parallel rendering paths connected by lines with an "OR" notation indicating alternative output modalities, are four renderer blocks: "Visual Renderer 1508" to the upper right, representing a renderer that generates visual text or graphical representations of the interpreted speech; "Audio Renderer 1510A" below the visual renderer, representing a renderer that generates synthesized audio speech outputs; "Braille Renderer 1510B" below the audio renderer, representing a renderer that generates Braille outputs for passengers with visual impairments; and "Haptic Renderer 1512" below the Braille renderer, representing a renderer that generates haptic feedback outputs. To the far right of the diagram is a block labeled "Remote Output 1514," representing the transmission of one or more of the rendered accessibility outputs to remote communication endpoints.

In use, speech input (1502) is received from a passenger’s active communication session and processed by the Interpretation Engine 1504, which generates an interpreted communication representation of the speech content. Depending on the passenger’s accessibility profile and rendering preferences, the interpreted representation is rendered through one or more of the available output modalities: Visual Renderer 1508 generates synchronized text captions or visual displays; Audio Renderer 1510A generates synthesized or regenerated speech outputs; Braille Renderer 1510B generates Braille-encoded textual outputs for passengers using Braille display devices; and Haptic Renderer 1512 generates haptic feedback signals for passengers using haptic communication interfaces. One or more rendered outputs may be transmitted to Remote Output 1514 for delivery to remote communication participants who may also have accessibility requirements. This multi-modal rendering architecture directly supports passengers with impaired speech, hearing impairments, visual impairments, neurological communication impairments, and other communication disabilities—addressing a documented deficiency in prior art transportation communication systems, including those disclosed in U.S. Patent Application Publication No. 2025/0273197, which provides only one-directional crew-to-passenger announcement transcription without the multi-modal, passenger-specific, bidirectional rendering of the present disclosure.

FIG. 16 – Distributed Interpreted Speech Synchronization System

FIG. 16 is a block diagram depicting the distributed interpreted speech synchronization system. The diagram is presented in two parallel vertical columns, each column representing a processing pathway for a separate communication participant, illustrating the synchronization of interpreted speech and caption streams between two parties. In each column, the blocks from top to bottom are: "User Speech 1602," representing the raw speech input from the user; "Local Processor 1604," representing the local processing of the speech signal on the user’s device; "Cloud Speech Model 1606," representing the cloud-hosted speech recognition and interpretation model that processes the conditioned speech signal; "Interpreted Text 1608," representing the textual output generated by the speech model; "Synthetic Speech 1610," representing the synthesized speech generated from the interpreted text; and "Caption Stream 1612," representing the synchronized caption stream generated from the interpreted text. At the bottom of each column is a block labeled "Remote Devices 1614," representing the remote communication endpoints to which interpreted text, synthetic speech, and caption streams are transmitted. A small icon labeled “CC” adjacent to Caption Stream 1612 indicates closed-captioning output. The dual-column layout with synchronized elements at corresponding vertical positions indicates the parallel, synchronized processing of speech from two simultaneous communication participants.

In use, User Speech 1602 from each communication participant is captured and processed through Local Processor 1604, which applies initial signal conditioning before transmitting the conditioned signal to Cloud Speech Model 1606. The Cloud Speech Model 1606—which may comprise the user-associated speech rehabilitation models described in connection with the parent application, U.S. Patent Application Serial No. 19/287,882—generates Interpreted Text 1608 from the conditioned speech. Interpreted Text 1608 is used simultaneously to generate Synthetic Speech 1610 for audio accessibility rendering and Caption Stream 1612 for visual accessibility rendering. Both the synthetic speech and caption streams are synchronized and transmitted to Remote Devices 1614, ensuring that communication accessibility outputs are available to all participants in the communication session regardless of their accessibility requirements. The distributed, cloud-synchronized architecture ensures that interpreted speech and caption streams remain synchronized across all endpoints even when participants are located in different transportation environments or on different network segments, addressing a deficiency in prior art systems that lack this distributed synchronization capability.

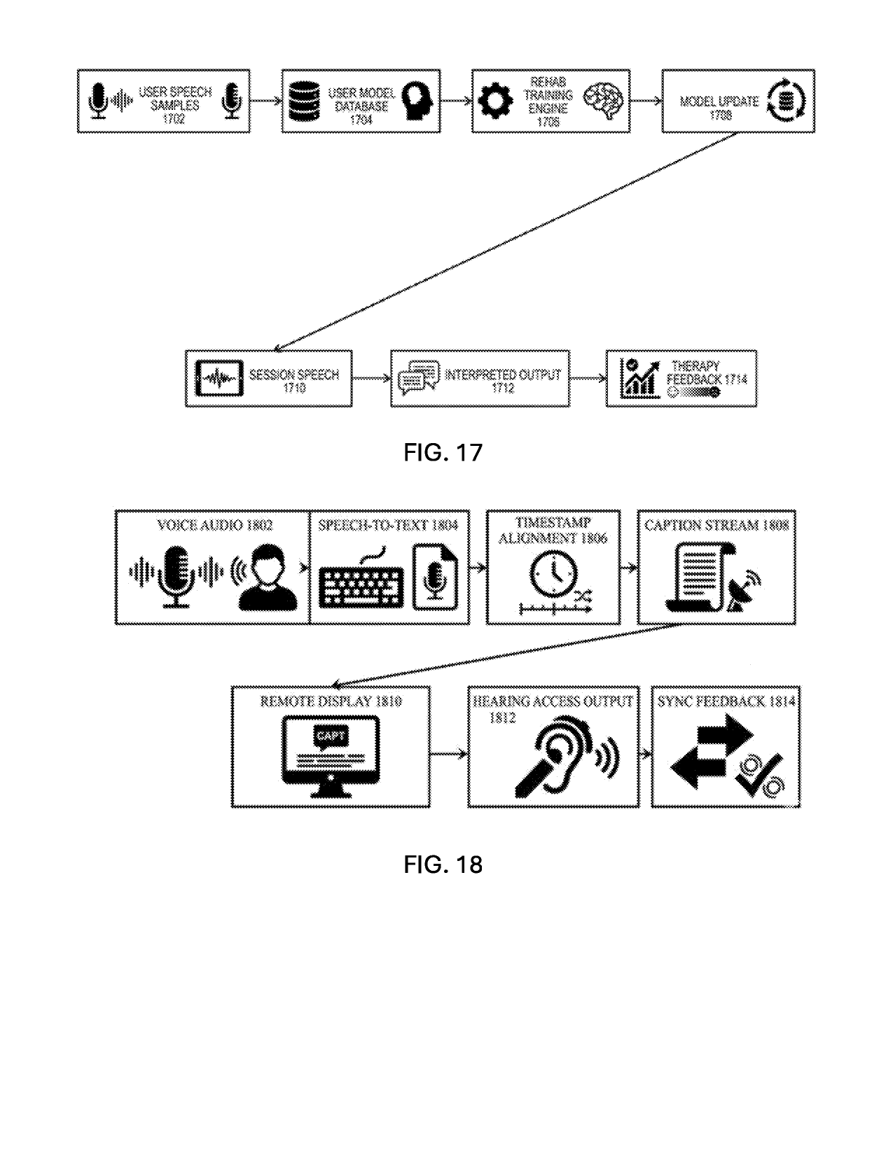

FIG. 17 – User-Associated Speech Model and Rehabilitation Processing Architecture

FIG. 17 is a block diagram depicting the user-associated speech model and rehabilitation processing architecture. On the left side of the diagram at the top is a block labeled "User Speech Samples 1702," representing the collection of speech samples from a specific user that form the basis for training the user’s personalized speech model. Below it and to the right is a block labeled "User Model Database 1704," representing the database that stores the user’s personalized speech model, including phonetic mappings, vocabulary mappings, and associated intelligible representations. Below the user model database is a block labeled "Rehab Training Engine 1706," representing the machine-learning system that trains and updates the user’s speech model based on new speech samples and feedback data. To the right of the rehab training engine is a block labeled "Model Update 1708," representing the process of updating the stored speech model with newly trained parameters. On the lower left of the diagram is a block labeled "Session Speech 1710," representing the real-time speech input from the user during an active communication session. Connected from the session speech block to the right is a block labeled "Interpreted Output 1712," representing the interpreted speech or text output generated by comparing the user’s session speech against the personalized speech model. Below the interpreted output block is a block labeled "Therapy Feedback 1714," representing data fed back into the rehabilitation training engine to continuously improve model accuracy.

In use, User Speech Samples 1702 are collected during initialization and ongoing use of the system and stored in User Model Database 1704. The Rehab Training Engine 1706 applies machine-learning algorithms—including adaptive neural-network models, reinforcement-learning systems, and probabilistic interpretation systems as described in the parent application, U.S. Patent Application Serial No. 19/287,882—to train and update the user’s personalized speech model, with updated parameters stored through Model Update 1708. During an active communication session, Session Speech 1710 is compared against the user’s personalized speech model to generate Interpreted Output 1712—comprising intelligible text representations or synthesized speech outputs that correspond to the user’s intended utterances even when those utterances are partially unintelligible due to speech impairments. Therapy Feedback 1714 captures session interpretation outcomes and feeds them back into the Rehab Training Engine 1706, enabling the system to continuously improve interpretation accuracy over time. This architecture builds upon the impaired speech analysis capabilities disclosed in the parent application, U.S. Patent Application Serial No. 19/287,882, by integrating those capabilities within the transportation-provider-managed governance framework of the present disclosure.

FIG. 18 – Synchronized Caption and Hearing Accessibility Workflow

FIG. 18 is a flow diagram depicting the synchronized caption and hearing accessibility workflow. The diagram presents seven rectangular process blocks arranged vertically from top to bottom, connected by downward-pointing arrows. The first block at the top is labeled "Voice Audio 1802," representing the voice audio input from a communication session participant. The second block is labeled "Speech-to-Text 1804," representing the conversion of the voice audio to text using speech recognition processing. The third block is labeled "Timestamp Alignment 1806," representing the alignment of the generated text segments with precise temporal timestamps corresponding to the original voice audio. The fourth block is labeled "Caption Stream 1808," representing the synchronized caption stream generated from the timestamp-aligned text. The fifth block is labeled "Remote Display 1810," representing the rendering of the caption stream on remote communication endpoints, such as the display screens of other communication participants. The sixth block is labeled "Hearing Access Output 1812," representing the accessibility output delivered to hearing-impaired participants in accessible formats, which may include large-format text, high-contrast display, or haptic representations. The final block at the bottom is labeled "Sync Feedback 1814," representing the feedback mechanism that monitors caption synchronization quality and adjusts timestamp alignment parameters to maintain synchronization accuracy.

In use, Voice Audio 1802 from an active communication session is processed through Speech-to-Text 1804 to generate textual representations of the spoken content. Timestamp Alignment 1806 aligns the generated text segments with precise timing references derived from the original audio stream, enabling captions to be synchronized with the audio at the word or phrase level. The aligned text is formatted as a Caption Stream 1808 and transmitted to Remote Display 1810 for rendering on the display devices of remote communication participants. Hearing Access Output 1812 delivers the accessibility-formatted caption content to hearing-impaired participants, with rendering parameters—such as font size, contrast level, and display position—adapted according to the passenger’s accessibility profile. Sync Feedback 1814 monitors the synchronization quality of the caption stream and feeds correction signals back to Timestamp Alignment 1806 to maintain caption synchronization within acceptable latency tolerances. This architecture is distinguished from the Airbus announcement transcription system of U.S. Patent Application Publication No. 2025/0273197 A1 by its operation within bidirectional passenger communication sessions, its synchronized timestamp alignment, and its integration with the transportation-provider-managed governance and accessibility profile systems of the present disclosure.

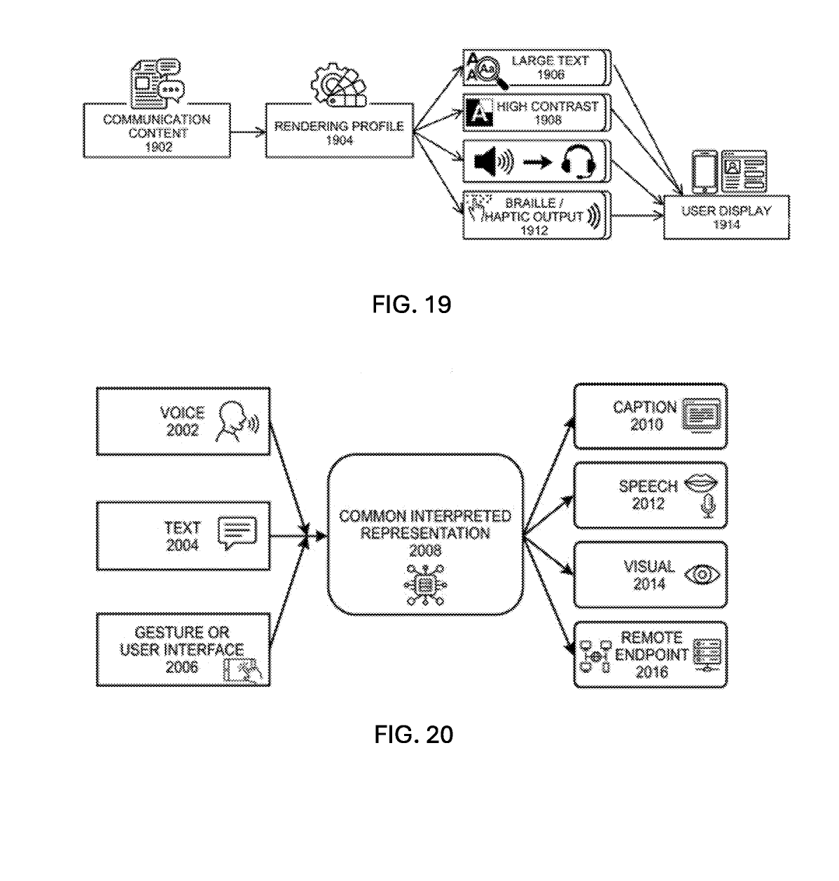

FIG. 19 – Vision Accessibility and Configurable Rendering Output Architecture

FIG. 19 is a block diagram depicting the vision accessibility and configurable rendering output architecture. At the top left of the diagram is a block labeled "Communication Content 1902," representing the incoming communication content—such as interpreted speech text, received messages, or conference content—to be rendered for a vision-impaired passenger. Below it is a block labeled "Rendering Profile 1904," representing the passenger-specific accessibility rendering profile that governs how communication content is formatted and displayed. To the right of the rendering profile block, branching into multiple parallel rendering option blocks connected by lines, are four rendering configuration blocks: "Large Text 1906," representing the rendering of communication content in enlarged text format suitable for passengers with reduced visual acuity; "High Contrast 1908," representing the rendering of communication content in high-contrast display formats—such as white text on black background or yellow on black—suitable for passengers with color vision deficiencies or low-contrast sensitivity; "Braille/Haptic Output 1912," representing the rendering of communication content as Braille-encoded output or haptic feedback signals for passengers with severe visual impairments who use tactile communication interfaces; and below these, "User Display 1914," representing the passenger’s personal display device on which the configured accessibility rendering is presented.

In use, Communication Content 1902 is processed according to the passenger’s Rendering Profile 1904, which specifies the accessibility rendering configurations required for the individual passenger’s visual accessibility needs. Depending on the profile, the system renders the content using Large Text 1906 formatting, High Contrast 1908 formatting, or Braille/Haptic Output 1912, and delivers the configured rendering to User Display 1914 for presentation to the passenger. The rendering profile is stored in the Accessibility Model 1416 of the Cloud Synchronization Core 1412 and is synchronized across transportation environments, ensuring that a passenger’s accessibility rendering preferences follow them throughout their journey. This architecture provides configurable, profile-driven visual accessibility rendering that is absent from prior art transportation communication systems and that directly supports the category of visual accessibility needs identified in the background of the present disclosure as unaddressed by existing systems.

FIG. 20 – Common Interpreted Representation Synchronization Architecture

FIG. 20 is a block diagram depicting the common interpreted representation synchronization architecture. On the left side of the diagram are three input blocks arranged vertically, representing the multiple modalities of communication input: "Voice 2002" at the top, representing voice communication input; "Text 2004" in the middle, representing text-based communication input; and "Gesture or User Interface 2006" at the bottom, representing gesture inputs or user interface inputs from accessibility devices. All three input blocks feed by arrows into a central block labeled "Common Interpreted Representation 2008," representing the normalized, modality-agnostic representation of the communication content generated from the various input modalities. On the right side of the diagram, three output blocks are connected from the Common Interpreted Representation block by arrows: "Caption 2010" at the top, representing caption output generated from the common representation; "Speech 2012" in the middle, representing synthesized speech output generated from the common representation; and "Visual 2014" at the bottom, representing visual rendering output generated from the common representation. At the far right is a block labeled "Remote Endpoint 2016," representing the remote communication endpoint to which the synchronized outputs are transmitted.

In use, communication inputs received through multiple modalities—voice (2002), text (2004), and gesture or user interface (2006)—are processed to generate a Common Interpreted Representation 2008 that normalizes the content of the communication regardless of its input modality. The common representation serves as a single source from which all output modalities—Caption 2010, Speech 2012, and Visual 2014—are generated synchronously, ensuring that all accessibility rendering outputs are temporally and substantively synchronized. This architecture guarantees that caption, speech, and visual outputs are derived from the same underlying interpreted representation, eliminating timing discrepancies or content divergences that could result from independent, parallel processing pipelines. The synchronized outputs are transmitted to Remote Endpoint 2016 for delivery to remote communication participants, ensuring end-to-end synchronization of accessibility rendering across all participants in the communication session. This common-representation architecture distinguishes the present disclosure from prior art systems that generate accessibility outputs through independent processing pipelines without a unifying common interpreted representation.

FIG. 21 – Acoustic Attenuation Speech Acquisition Support Architecture

FIG. 21 is a block diagram depicting the acoustic attenuation speech acquisition support architecture. The diagram presents seven rectangular blocks arranged in a vertical sequence from top to bottom, connected by downward-pointing arrows indicating the flow of the speech signal. The first block at the top is labeled "User Mouth 2102," representing the acoustic source of the speech signal—the user’s mouth. The second block is labeled "Acoustic Attenuator 2104," representing the passive acoustic attenuator that receives the voice from the user’s mouth and reduces the sound pressure level of the incoming acoustic signal before it reaches the microphone. The third block is labeled "Protected Microphone 2106," representing the microphone protected by the acoustic attenuator that converts the attenuated acoustic signal to an electrical signal while avoiding distortion from high sound pressure levels. The fourth block is labeled "Signal Conditioner 2108," representing the signal conditioning system that applies amplification, equalization, noise reduction, and digital filtering to the electrical signal. The fifth block is labeled "Wireless Device 2110," representing the wireless communication device—such as a Bluetooth chip or wireless transceiver—that transmits the conditioned signal to the governance system. The sixth block is labeled "Governance System 2112," representing the Transportation Governance System 100 that receives the conditioned speech signal and subjects it to the transportation-provider communication governance framework. The final block at the bottom is labeled "Remote Call 2114," representing the remote communication session through which the governed speech is transmitted to remote participants.

In use, a user speaks from User Mouth 2102 into the Acoustic Attenuator 2104, which reduces the sound pressure level of the voice signal before it reaches the Protected Microphone 2106, preventing distortion of the electrical signal at high sound pressure levels as described in detail in the parent application, U.S. Patent Application Serial No. 19/287,882. The Protected Microphone 2106 converts the attenuated acoustic signal to an electrical signal, which is then processed by Signal Conditioner 2108 to enhance signal clarity through amplification, equalization, noise reduction, and digital filtering. The conditioned signal is transmitted via Wireless Device 2110 to Governance System 2112, where it is subject to the communication authorization, quality-of-service governance, and accessibility rendering processes of the Transportation Governance System 100. The governed speech is then transmitted through Remote Call 2114 to remote communication participants. This architecture demonstrates the integration of the acoustic attenuation hardware disclosed in the parent application, U.S. Patent Application Serial No. 19/287,882, with the transportation-provider-managed communication governance framework of the present disclosure, providing an optional but advantageous hardware interface for users requiring acoustic attenuation—particularly those with impaired speech who rely on the acoustic attenuation and interpreted speech capabilities of the parent patent family.

FIG. 22 – Conferencing and Collaboration Governance System

FIG. 22 is a block diagram depicting the conferencing and collaboration governance system. On the left side of the diagram are three blocks arranged vertically, representing individual conferencing participants: "Participant A 2202" at the top, "Participant B 2204" in the middle, and "Participant C 2206" at the bottom. Each participant block is connected by a horizontal arrow to a central block labeled "Conference Service 2208," representing the conferencing platform or service through which the participants’ communication sessions are routed. To the right of the conference service block is a block labeled "Governance Gateway 2210," representing the transportation-provider governance gateway through which all conferencing session traffic passes for authorization and governance enforcement. To the right of the governance gateway are three subordinate function blocks arranged vertically: "Policy Engine 2212" at the top, representing the policy enforcement component of the governance gateway; "QoS Manager 2214" in the middle, representing the quality-of-service management component; and "Audit Log 2216" at the bottom, representing the audit logging component that records all governance actions taken with respect to the conference session.

In use, Participants A (2202), B (2204), and C (2206) join a multi-party conference session through Conference Service 2208. All conferencing traffic is routed through Governance Gateway 2210, which enforces transportation-provider communication policies through Policy Engine 2212, applies quality-of-service parameters through QoS Manager 2214, and records all governance events in Audit Log 2216. The Governance Gateway 2210 validates each participant’s communication authorization token, confirms that the conferencing session is permissible under current operational transportation conditions, and applies applicable bandwidth and accessibility rendering parameters. This architecture enables the present disclosure to govern multi-party conferencing sessions within transportation environments—a capability absent from prior art systems, including the conference session governance approach of U.S. Patent Application Publication No. 2025/0045859 (NEC Corporation), which addresses informational token allocation but does not disclose transportation-provider governance of multi-party communication conferencing sessions.

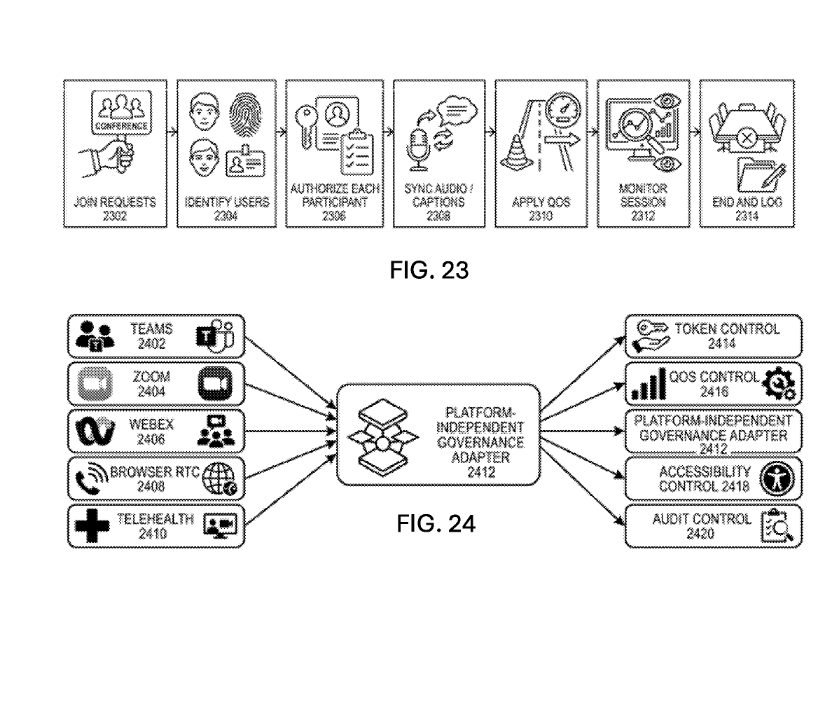

FIG. 23 – Multiuser Conferencing Synchronization Workflow

FIG. 23 is a flow diagram depicting the multiuser conferencing synchronization workflow. The diagram presents seven rectangular process blocks arranged vertically from top to bottom, connected by downward-pointing arrows. A label at the top reading "CONFERENCE" contextualizes the workflow. The first block at the top is labeled "Join Requests 2302," representing the receipt of join requests from all conference participants seeking to enter the governed conference session. The second block is labeled "Identify Users 2304," representing the identification of each joining participant by passenger identifier, seat identifier, or communication account credentials. The third block is labeled "Authorize Each Participant 2306," representing the individual authorization of each participant’s communication authorization token and verification that each participant’s session is permissible under applicable policies. The fourth block is labeled "Sync Audio/Captions 2308," representing the synchronization of audio streams and caption outputs across all authorized participants. The fifth block is labeled "Apply QoS 2310," representing the application of quality-of-service parameters to each participant’s session traffic based on their authorization classification and accessibility requirements. The sixth block is labeled "Monitor Session 2312," representing the ongoing monitoring of the conference session for policy compliance, token validity, and accessibility rendering quality. The final block at the bottom is labeled "End and Log 2314," representing the conclusion of the conference session and the recording of the session in the audit log.

In use, as conference participants submit Join Requests 2302, the system identifies each participant (2304) and performs individual authorization checks against each participant’s communication authorization token and applicable policies (2306). Upon successful authorization of all participants, the system synchronizes audio streams and caption outputs across all endpoints (2308) and applies appropriate quality-of-service parameters to each participant’s session traffic (2310). The governance system continuously monitors the conference session for token validity, policy compliance, and accessibility rendering quality (2312), and may revoke individual participants’ authorization tokens and remove them from the conference in response to policy violations, token expiration, or administrative override commands. Upon session conclusion, all session data is logged (2314) for compliance and audit purposes. This sequential, participant-by-participant authorization workflow distinguishes the present disclosure from prior art conferencing governance systems that do not apply transportation-provider communication policy governance to individual conferencing participants.

FIG. 24 – Platform-Independent Conferencing Governance Architecture

FIG. 24 is a block diagram depicting the platform-independent conferencing governance architecture. On the left side of the diagram are five blocks arranged vertically, each representing a distinct conferencing or collaboration platform: "Teams 2402" at the top, representing Microsoft Teams; "Zoom 2404" below it, representing Zoom video conferencing; "Webex 2406" below that, representing Cisco Webex; "Browser RTC 2408" below that, representing browser-based real-time communication platforms using WebRTC or similar protocols; and "Telehealth 2410" at the bottom, representing telehealth communication platforms. All five platform blocks are connected by horizontal arrows pointing to a central block labeled "Platform-Independent Governance Adapter 2412," representing the governance adapter layer that provides a unified governance interface across all conferencing platforms. To the right of the governance adapter block are four subordinate function blocks arranged vertically: "Token Control 2414" at the top, representing communication authorization token control functions; "QoS Control 2416" below it, representing quality-of-service management functions; "Accessibility Control 2418" below that, representing accessibility rendering and configuration functions; and "Audit Control 2420" at the bottom, representing audit logging and compliance functions.

In use, the Platform-Independent Governance Adapter 2412 provides a normalized governance interface that applies transportation-provider communication governance—including Token Control 2414, QoS Control 2416, Accessibility Control 2418, and Audit Control 2420—to conferencing and collaboration sessions conducted through any of the supported platforms: Teams (2402), Zoom (2404), Webex (2406), Browser RTC (2408), or Telehealth (2410). The governance adapter operates independently of the conferencing platform’s native governance mechanisms, inserting transportation-provider policy enforcement at the network and session control layer rather than at the application layer, enabling consistent governance regardless of the conferencing platform in use. This platform-agnostic governance architecture directly addresses the identified deficiency that existing conferencing systems fail to provide transportation-provider-managed communication governance, and it distinguishes the present disclosure from prior art systems that are limited to specific communication platforms or device types.

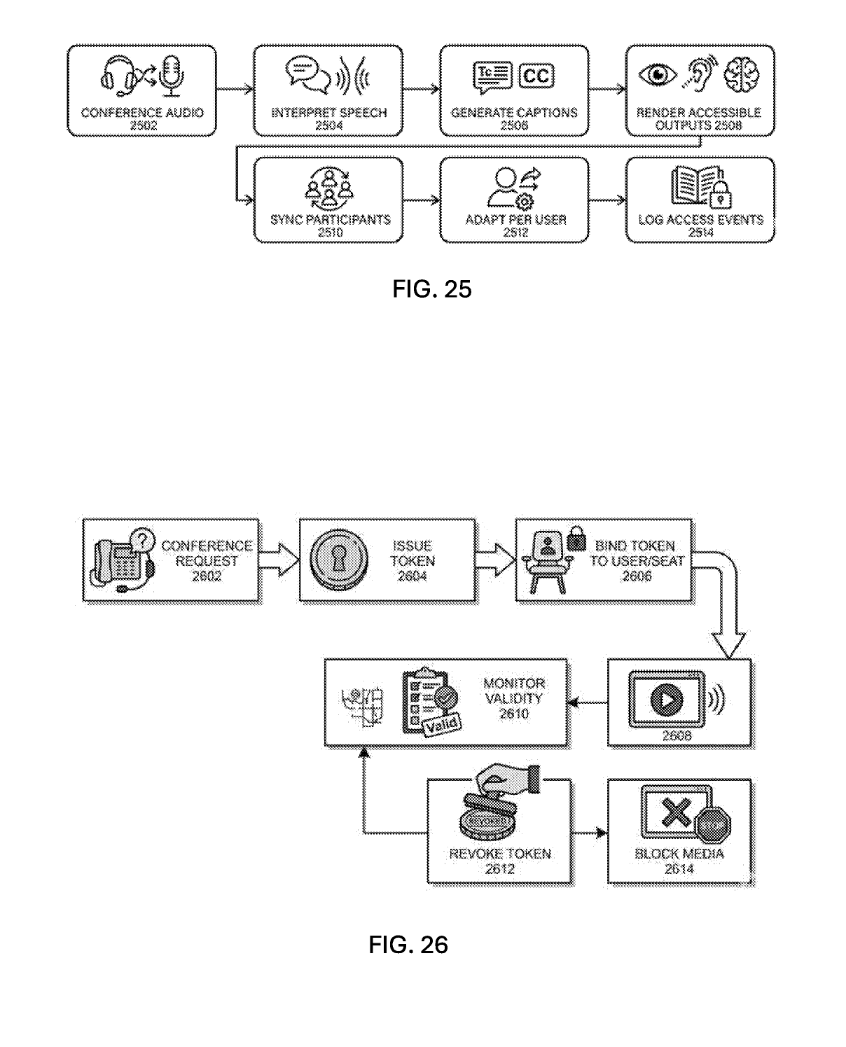

FIG. 25 – Accessibility Conferencing Rendering and Synchronization Workflow

FIG. 25 is a flow diagram depicting the accessibility conferencing rendering and synchronization workflow. The diagram presents seven rectangular process blocks arranged vertically from top to bottom, connected by downward-pointing arrows. The first block at the top is labeled "Conference Audio 2502," representing the composite audio stream from an active multi-party conference session. The second block is labeled "Interpret Speech 2504," representing the application of speech interpretation processing to the conference audio to generate interpreted textual representations of the spoken content. The third block is labeled "Generate Captions 2506"—accompanied by a small icon labeled “CC” indicating closed captioning—representing the generation of synchronized caption streams from the interpreted text. The fourth block is labeled "Render Accessible Outputs 2508," representing the rendering of the conference content into accessibility-formatted outputs, which may include synchronized captions, synthesized speech, large-format text, high-contrast displays, or Braille/haptic outputs, according to each participant’s accessibility profile. The fifth block is labeled "Sync Participants 2510," representing the synchronization of the accessibility rendering outputs across all conference participants. The sixth block is labeled "Adapt Per User 2512," representing the adaptation of rendering parameters for each individual participant based on their stored accessibility profile and real-time rendering feedback. The final block at the bottom is labeled "Log Access Events 2514," representing the recording of all accessibility rendering events in the audit infrastructure.

In use, the composite Conference Audio 2502 is processed through Interpret Speech 2504 to generate interpreted textual representations of all participants’ spoken contributions. Generate Captions 2506 formats the interpreted text as synchronized caption streams with closed-captioning encoding. Render Accessible Outputs 2508 applies participant-specific accessibility rendering configurations to the interpreted content, generating output formats appropriate for each participant’s accessibility needs—including synchronized captions, synthesized speech, large text, high-contrast rendering, or Braille/haptic output. Sync Participants 2510 ensures that all accessibility rendering outputs are synchronized across all conference endpoints, and Adapt Per User 2512 continuously refines rendering parameters for each participant based on their accessibility profile and real-time quality feedback. All accessibility rendering events are recorded by Log Access Events 2514 for compliance and audit purposes. This comprehensive conference accessibility workflow provides capabilities absent from all prior art conferencing systems operating within transportation environments, including the announcement transcription system of U.S. Patent Application Publication No. 2025/0273197, which does not govern individual passenger conferencing sessions.

FIG. 26 – Tokenized Conferencing Authorization and Revocation Workflow

FIG. 26 is a flow diagram depicting the tokenized conferencing authorization and revocation workflow. The diagram presents a branching decision-based flow. At the top is a block labeled "Conference Request 2602"—accompanied by a question mark symbol—representing the initiation of a conference session authorization request. Below it is a block labeled "Issue Token 2604," representing the issuance of a communication authorization token upon initial verification of the conference request. Below the token issuance block is a block labeled "Bind Token to User/Seat 2606," representing the association of the issued token with the specific passenger’s identity and seat assignment. Below the token-binding block, the workflow branches based on a validity determination labeled "2608": the “Valid” branch leads to a block labeled "Monitor Validity 2610," representing the ongoing monitoring of the token’s validity during the conference session; the “Revoked” branch leads to a block labeled "Revoke Token 2612," representing the revocation of the token in response to an expiration, policy violation, or administrative override command. Below the revocation block is a block labeled "Block Media 2614"—accompanied by an “X STOP” symbol indicating session termination—representing the termination of active media streams associated with the revoked token.

In use, when a passenger submits a Conference Request 2602, the governance system evaluates the request and, upon successful authorization, Issues Token 2604 and Binds Token to User/Seat 2606, associating the conference session authorization with the specific passenger’s identity and seat. The governance system then continuously Monitors Validity 2610 of the token throughout the conference session, checking for token expiration, policy changes, operational transportation condition changes, and administrative override commands. If the token remains valid (2608 “Valid”), the monitoring continues. If the token is revoked—due to expiration, policy violation, operational transportation condition change, or administrative override—the system executes token Revoke (2612) and immediately Blocks Media (2614), terminating the active conference session media streams associated with the revoked token. This tokenized conference authorization and revocation workflow integrates the communication authorization token infrastructure of FIG. 2 with the conference-specific governance requirements, providing granular, real-time revocation capability that is absent from prior art conferencing systems and is distinguished from the binary device-level disable mechanism of U.S. Patent No. 10,044,842.

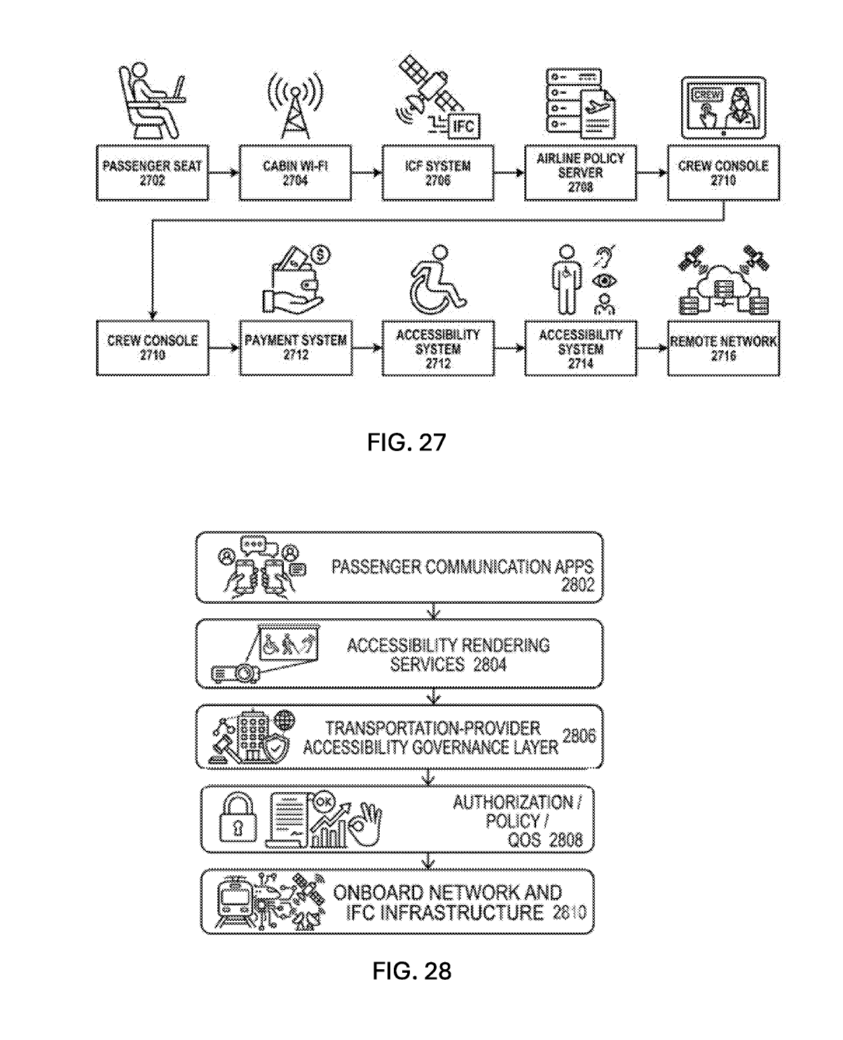

FIG. 27 – Integrated Airline Communication Governance Architecture

FIG. 27 is a block diagram depicting the integrated airline communication governance architecture. The diagram presents an interconnected set of components representing the full airline-specific implementation of the transportation-provider-managed communication governance system. On the left side is a block labeled "Passenger Seat 2702," representing the physical location of the passenger within the aircraft cabin and the origin point of passenger communication sessions. Above it is a block labeled "Cabin Wi-Fi 2704," representing the onboard wireless communication network serving the aircraft cabin. To the right of the cabin Wi-Fi block is a block labeled "IFC System 2706," representing the in-flight connectivity system that provides the aircraft with external communication links. To the right of the IFC system is a block labeled "Airline Policy Server 2708," representing the server that enforces the airline’s transportation-provider communication policies. Below the airline policy server is a block labeled "Crew Console 2710," representing the crew’s administrative override interface. To the right of the airline policy server is a block labeled "Payment System 2712," representing the communication monetization and billing infrastructure. Below the payment system is a block labeled "Accessibility System 2714," representing the accessibility communication rendering infrastructure. At the far right is a block labeled "Remote Network 2716," representing the external internet and communication network accessed through the in-flight connectivity system.

In use, a passenger initiates a communication session from Passenger Seat 2702 through Cabin Wi-Fi 2704, which routes the session request through IFC System 2706 to Airline Policy Server 2708. The Airline Policy Server 2708 validates the passenger’s communication authorization credentials, enforces applicable communication policies, and authorizes the session. Crew Console 2710 provides airline crew with real-time monitoring and administrative override capabilities. Payment System 2712 processes communication charges and allocates revenue according to pre-configured sharing agreements among the airline, the IFC provider, and the governance system provider. Accessibility System 2714 provides accessibility communication rendering services for passengers with communication disabilities, generating synchronized interpreted speech outputs, captions, synthesized speech, and other accessibility rendering outputs according to passenger accessibility profiles. Authorized sessions are routed through IFC System 2706 to Remote Network 2716. This integrated architecture demonstrates the airline-specific implementation of the comprehensive transportation governance framework of the present disclosure, providing a complete governance infrastructure from passenger seat to remote network that is absent from prior art airline communication systems, including those disclosed in U.S. Patent No. 10,460,730 and U.S. Patent Application Publication No. 2016/0372114.

FIG. 28 – Transportation-Provider Accessibility Governance Layer

FIG. 28 is a block diagram depicting the transportation-provider accessibility governance layer as a layered stack architecture. The diagram presents five horizontal rectangular blocks stacked vertically from top to bottom, representing successive architectural layers of the accessibility governance infrastructure. The topmost layer is labeled "Passenger Communication Apps 2802," representing the communication applications operating on passenger devices—including VoIP applications, conferencing apps, telehealth platforms, and browser-based communication interfaces. The second layer below is labeled "Accessibility Rendering Services 2804," representing the suite of accessibility rendering services—including interpreted speech, synchronized captions, synthesized speech, visual rendering, Braille output, and haptic feedback—that process communication content for accessibility delivery. The third layer is labeled "Transportation-Provider Accessibility Governance Layer 2806," representing the core governance layer that applies transportation-provider accessibility policies, manages accessibility token authorization, and coordinates accessibility rendering service delivery. The fourth layer is labeled "Authorization/Policy/QoS 2808," representing the authorization, policy enforcement, and quality-of-service management functions that underlie the accessibility governance layer. The bottom layer is labeled "Onboard Network and IFC Infrastructure 2810," representing the physical onboard network and in-flight connectivity infrastructure that provides the communication transport for all layers above.

In use, Passenger Communication Apps 2802 operating on passenger devices access Accessibility Rendering Services 2804 through the Transportation-Provider Accessibility Governance Layer 2806, which enforces transportation-provider accessibility policies and manages accessibility session authorization. The Authorization/Policy/QoS layer 2808 provides the authorization token validation, policy enforcement, and quality-of-service management functions that govern the accessibility rendering services, ensuring that accessibility traffic receives appropriate prioritization through the Onboard Network and IFC Infrastructure 2810. This layered architecture separates the governance, rendering, and infrastructure concerns of the accessibility system into distinct functional layers, enabling independent evolution and update of each layer without disrupting the others. The Transportation-Provider Accessibility Governance Layer 2806 is the distinguishing architectural element of the present disclosure—providing the transportation-provider-specific governance that is absent from general-purpose accessibility rendering systems and from prior art transportation communication systems that lack dedicated accessibility governance infrastructure.

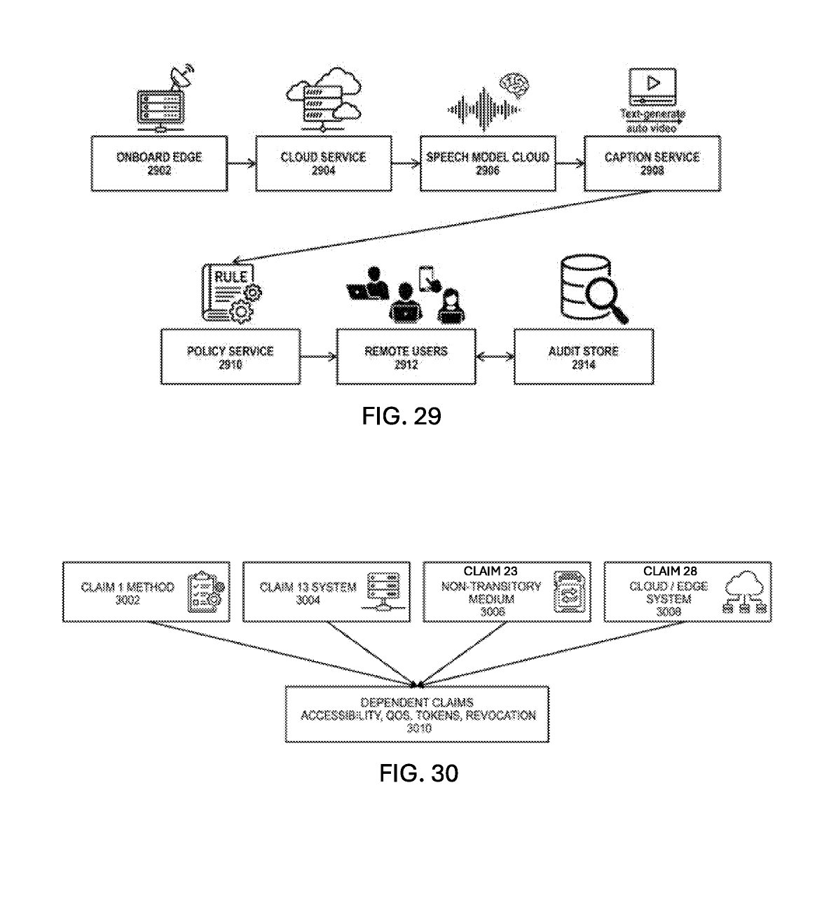

FIG. 29 – Distributed Cloud Communication and Accessibility Synchronization Architecture

FIG. 29 is a block diagram depicting the distributed cloud communication and accessibility synchronization architecture. On the left side of the diagram is a block labeled "Onboard Edge 2902," representing the edge-computing infrastructure operating within the transportation vehicle that provides low-latency processing proximate to the passenger communication environment. To the upper right of the onboard edge block is a block labeled "Cloud Service 2904," representing the cloud-hosted communication and governance service infrastructure. Below the cloud service block and to its right are two specialized cloud service blocks: "Speech Model Cloud 2906," representing the cloud-hosted speech recognition and rehabilitation model processing services; and "Caption Service 2908," representing the cloud-hosted caption generation and synchronization services. Below those blocks is a block labeled "Policy Service 2910," representing the cloud-hosted policy repository and enforcement service. To the lower right is a block labeled "Remote Users 2912," representing remote communication participants accessing the system from outside the transportation environment. At the bottom right is a block labeled "Audit Store 2914," representing the distributed cloud-hosted audit database. Bidirectional arrows connecting these blocks indicate the flow of communication data, governance instructions, accessibility model parameters, caption streams, policy updates, and audit records among the distributed components. A label visible near the Speech Model Cloud block reads “Text-generate auto video,” indicating an auto-captioning and text generation function.

In use, Onboard Edge 2902 handles time-sensitive communication governance functions—including token validation, quality-of-service enforcement, and initial speech processing—with low latency by operating proximate to the passenger communication environment. Cloud Service 2904 provides the broader communication infrastructure, coordinating with Speech Model Cloud 2906 for speech recognition and accessibility model processing, with Caption Service 2908 for synchronized caption generation, and with Policy Service 2910 for policy repository maintenance and enforcement. Remote Users 2912 communicate with the governed transportation environment through the cloud infrastructure, and all governance events are recorded in Audit Store 2914. The distributed edge-cloud architecture ensures that accessibility-critical functions—such as real-time speech interpretation and synchronized caption generation—operate with the low latency required for effective accessibility rendering, while policy management and audit functions leverage cloud scalability. This architecture is distinguished from centralized accessibility rendering approaches by its distributed edge-cloud design, and from prior art speech-to-text systems such as U.S. Patent Application Publication No. 2025/0273197 by its integration within the comprehensive transportation-provider-managed communication governance framework of the present disclosure.

FIG. 30 – Integrated Track One Claim Architecture Overview

FIG. 30 is a block diagram depicting the integrated Track One claim architecture overview. The diagram presents five rectangular blocks. The first block at the upper left is labeled "Claim 1 Method 3002," representing the independent method claim of the present application directed to the computer-implemented method for selectively governing passenger communication sessions operating within a transportation-provider-managed communication environment. The second block at the upper right is labeled "Claim 13 System 3004," representing the independent system claim directed to the transportation-provider-managed multimodal communication system. The third block at the lower left is labeled "Claim 23 Non-Transitory Medium 3006," representing the independent computer-readable storage medium claim. The fourth block at the lower right is labeled "Claim 28 Cloud/Edge System 3008," representing claims directed to distributed cloud and edge computing implementations. The fifth block spanning the bottom of the diagram is labeled "Dependent Claims: Accessibility, QoS, Tokens, Revocation 3010," representing the dependent claims that further define the accessibility communication rendering, quality-of-service prioritization, communication authorization token, and session revocation aspects of the invention.

In use, FIG. 30 provides a visual summary of the claim architecture of the present application, illustrating the structural relationship among the independent claims and the dependent claim categories. Claim 1 Method (3002) encompasses the method-based aspects of the invention, including the steps of receiving communication requests, processing authorization credentials, generating communication authorization tokens, establishing real-time communication sessions, and selectively governing those sessions. Claim 13 System (3004) encompasses the system-based aspects of the invention, including the onboard communication infrastructure, communication authorization systems, transportation-provider-managed communication governance systems, communication synchronization systems, accessibility communication rendering systems, and network communication systems. The Non-Transitory Medium claims (3006) encompass the computer-readable storage medium aspects of the invention. Dependent Claims (3010) collectively define the accessibility communication rendering, quality-of-service prioritization, communication authorization token, and session revocation subject matter that further specifies the independent claim elements across all independent claim types. This claim architecture provides comprehensive statutory subject matter coverage for the transportation-provider-managed communication governance system of the present disclosure.

### INCORPORATION BY REFERENCE

All claims set forth in this application are hereby incorporated by reference into the Detailed Description of the Invention as if fully set forth herein.

The entirety of each patent, patent application, publication, and document referenced herein is hereby incorporated by reference. The citation of any reference is not an admission that such reference constitutes prior art.

### EQUIVALENTS

Those skilled in the art will recognize, or be able to ascertain using no more than routine experimentation, many equivalents to the specific embodiments of the disclosed subject matter described herein. Such equivalents are intended to be encompassed by the following claims.

### VARIATIONS AND MODIFICATIONS

It is to be understood that while the invention has been described in conjunction with the preferred specific embodiments thereof, the foregoing description is intended to illustrate and not limit the scope of the invention. Other aspects, advantages, and modifications within the scope of the invention will be apparent to those skilled in the art to which the invention pertains.

### NON-LIMITING EMBODIMENTS

It is further to be understood that all values are approximate, and are provided for description. The embodiments described herein are exemplary. The disclosed systems, methods, and structures may be modified from the embodiments described herein without departing from the spirit and scope of the present disclosure. Accordingly, the specification and drawings are to be regarded in an illustrative rather than a restrictive sense.

### INTERPRETATION OF CLAIM LANGUAGE

The use of the terms "a," "an," "the," and similar referents in the context of describing the disclosed subject matter (especially in the context of the following claims) are to be construed to cover both the singular and the plural, unless otherwise indicated herein or clearly contradicted by context. The terms "comprising," "having," "including," and "containing" are to be construed as open-ended terms (i.e., meaning "including, but not limited to") unless otherwise noted. As used herein, the term "combinations thereof" includes any and all combinations of the listed elements. Recitation of ranges of values herein is merely intended to serve as a shorthand method of referring individually to each separate value falling within the range, unless otherwise indicated herein, and each separate value is incorporated into the specification as if it were individually recited herein.

The term "or" as used in the claims is used in its inclusive sense (i.e., "and/or") unless the context clearly requires otherwise.

### ORDER OF STEPS

The methods described herein can be performed in any suitable order unless otherwise indicated herein or otherwise clearly contradicted by context. The use of any and all examples, or exemplary language (e.g., "such as") provided herein is intended merely to better illuminate the disclosed subject matter and does not pose a limitation on the scope of the invention unless otherwise claimed.

### OPEN CLAIM SCOPE

No claim element herein is to be construed under the provisions of 35 U.S.C. § 112(f) unless the element is expressly recited using the phrase "means for." The present invention is not intended to be limited to the embodiments shown herein but is to be accorded the widest scope consistent with the principles and novel features disclosed herein.

### NO WAIVER

No language in the specification should be construed as indicating any non-claimed element as essential to the practice of the invention.

### TITLES AND HEADINGS

Section headings used herein are for organizational purposes only and are not to be construed as limiting the subject matter described in any way.

I claim:

1. A computer-implemented method for selectively governing passenger communication sessions operating within a transportation-provider-managed communication environment, the method comprising:
receiving, at a transportation-provider-managed communication infrastructure operating within a transportation environment, a communication request associated with a passenger-operated portable electronic communication device;
processing, using one or more transportation-provider-managed communication governance systems, one or more passenger-associated authorization credentials associated with the passenger-operated portable electronic communication device;
determining, using the one or more transportation-provider-managed communication governance systems, whether the passenger-operated portable electronic communication device is authorized to initiate a real-time communication session through an onboard wireless communication infrastructure;
generating, upon successful authorization, a communication authorization token associated with the real-time communication session;
establishing, using the communication authorization token, the real-time communication session between the passenger-operated portable electronic communication device and at least one remote communication system; and
selectively governing, synchronizing, prioritizing, monetizing, restricting, suspending, revoking, terminating, interpreting, rendering, allocating network resources to, or controlling, using the one or more transportation-provider-managed communication governance systems, the real-time communication session according to one or more transportation-provider communication policies, operational transportation conditions, accessibility communication classifications, conferencing classifications, monetization classifications, communication congestion conditions, bandwidth allocation conditions, or combinations thereof.

2. The method of claim 1, wherein the transportation environment comprises an aircraft communication environment, train communication environment, bus communication environment, maritime communication environment, transportation hub communication environment, passenger terminal communication environment, or distributed transportation communication environment.

3. The method of claim 1, wherein the passenger-operated portable electronic communication device comprises a smartphone, tablet computer, laptop computer, conferencing terminal, browser-enabled communication device, wearable communication device, accessibility communication device, or acoustic attenuation communication device.

4. The method of claim 1, wherein the communication authorization token is associated with a passenger seat assignment.

5. The method of claim 1, wherein the real-time communication session comprises a Voice over Internet Protocol communication session, conferencing communication session, browser-based communication session, enterprise collaboration session, telehealth communication session, distributed cloud communication session, or synchronized communication session.

6. The method of claim 1, further comprising selectively enabling or disabling the real-time communication session according to an operational transportation condition comprising taxi operations, takeoff operations, climb operations, cruise operations, descent operations, turbulence conditions, emergency operations, communication congestion conditions, bandwidth allocation conditions, or combinations thereof.

7. The method of claim 1, further comprising remotely terminating the real-time communication session using an administrative override interface associated with an authorized transportation-provider operator.

8. The method of claim 1, wherein the transportation-provider-managed communication governance systems selectively govern communication sessions independently of whether the passenger-operated portable electronic communication device comprises an acoustic attenuation structure, conferencing platform type, browser communication platform type, operating system type, communication endpoint type, communication application type, passenger-operated communication device manufacturer, conferencing provider, or Voice over Internet Protocol service provider.

9. The method of claim 1, further comprising processing passenger speech audio associated with the real-time communication session using a distributed speech rehabilitation processing infrastructure configured to generate interpreted speech outputs, synchronized caption outputs, synthesized speech outputs, regenerated speech outputs, textual outputs, visual accessibility outputs, multilingual accessibility outputs, or synchronized multimodal accessibility outputs.

10. The method of claim 1, further comprising synchronizing interpreted speech outputs and synchronized caption outputs across a plurality of communication participants operating within a conferencing communication session.

11. The method of claim 1, wherein the communication authorization token comprises encrypted authorization data associated with a passenger identifier, passenger seat identifier, authorization timestamp, communication classification, monetization classification, communication duration parameter, expiration parameter, or combinations thereof.

12. The method of claim 1, further comprising dynamically allocating communication bandwidth resources according to communication priority classifications, transportation-provider operational policies, communication congestion conditions, accessibility classifications, monetization classifications, or combinations thereof.

13. A transportation-provider-managed multimodal communication system, comprising:
an onboard communication infrastructure operating within a transportation-provider-managed communication environment and comprising at least one onboard wireless communication network;
one or more communication authorization systems configured to process passenger-associated authorization credentials associated with passenger-operated portable electronic communication devices;
one or more transportation-provider-managed communication governance systems configured to selectively authorize, synchronize, prioritize, monetize, meter, restrict, suspend, revoke, terminate, interpret, render, allocate network resources to, or control communication sessions associated with the passenger-operated portable electronic communication devices;
one or more communication synchronization systems configured to synchronize communication sessions operating across browser-based communication systems, conferencing systems, enterprise collaboration systems, telehealth communication systems, or distributed cloud communication systems;
one or more accessibility communication rendering systems configured to generate synchronized interpreted speech outputs, synchronized caption outputs, synthesized speech outputs, regenerated speech outputs, textual outputs, browser-based communication outputs, visual accessibility outputs, audio accessibility outputs, multilingual accessibility outputs, or synchronized multimodal accessibility outputs; and
one or more network communication systems configured to establish real-time communication sessions between authorized passenger-operated portable electronic communication devices and one or more remote communication systems.

14. The system of claim 13, wherein the onboard communication infrastructure comprises at least one onboard router, communication gateway, cabin wireless access point, satellite communication system, air-to-ground communication system, edge-computing infrastructure, or distributed cloud communication infrastructure.

15. The system of claim 13, wherein the passenger-operated portable electronic communication devices comprise smartphones, cellular telephones, tablet computers, laptop computers, conferencing terminals, browser-enabled communication devices, accessibility communication devices, or acoustic attenuation communication devices.

16. The system of claim 13, wherein the communication authorization systems comprise tokenized communication authorization systems configured to generate encrypted communication authorization tokens associated with passenger communication sessions.

17. The system of claim 13, wherein the transportation-provider-managed communication governance systems comprise administrative override systems configured to remotely terminate passenger communication sessions.

18. The system of claim 13, further comprising quality-of-service communication prioritization systems configured to prioritize conferencing communication traffic, Voice over Internet Protocol communication traffic, accessibility communication traffic, synchronized caption traffic, interpreted speech traffic, browser communication traffic, telehealth communication traffic, or combinations thereof.

19. The system of claim 13, further comprising communication monetization systems configured to associate communication charges with passenger authorization classifications, communication durations, conferencing classifications, accessibility classifications, subscription classifications, monetization classifications, or combinations thereof.

20. The system of claim 13, further comprising communication logging systems configured to maintain communication authorization records, passenger seat records, timestamp records, monetization records, accessibility communication records, synchronized caption records, interpreted speech records, administrative override records, bandwidth allocation records, communication congestion records, or combinations thereof.

21. The system of claim 13, wherein the accessibility communication rendering systems facilitate communication accessibility for users having impaired speech, hearing impairments, visual impairments, articulation impairments, neurological impairments, degenerative communication impairments, communication-processing impairments, or combinations thereof.

22. The system of claim 13, wherein the communication synchronization systems synchronize communication sessions across aircraft communication environments, train communication environments, maritime communication environments, bus communication environments, transportation hubs, passenger terminals, or distributed transportation communication environments.

23. A distributed interpreted speech synchronization system, comprising:
one or more speech acquisition systems configured to receive speech signals associated with one or more users;
one or more speech conditioning systems configured to generate conditioned communication signals from the speech signals;
one or more distributed speech rehabilitation processing systems configured to compare the conditioned communication signals with stored user-associated speech data comprising speech samples associated with corresponding intelligible representations;
one or more interpreted speech generation systems configured to identify one or more interpreted communication representations associated with the conditioned communication signals; and
one or more synchronized multimodal communication rendering systems configured to generate synchronized interpreted speech outputs, synchronized caption outputs, synthesized speech outputs, regenerated speech outputs, textual outputs, browser-based communication outputs, conferencing outputs, enterprise collaboration outputs, telehealth outputs, accessibility communication outputs, multilingual accessibility outputs, or synchronized multimodal communication outputs from the one or more interpreted communication representations.

24. The system of claim 23, wherein the stored user-associated speech data comprises user-specific vocabulary mappings, phonetic mappings, speech association mappings, speech rehabilitation mappings, machine-learning models, adaptive neural-network models, reinforcement-learning models, confidence-scoring data structures, probabilistic interpretation models, continuously updated speech samples, continuously updated interpreted speech association data, or combinations thereof.

25. The system of claim 23, wherein the one or more synchronized multimodal communication rendering systems are configured to generate synchronized audio outputs, synchronized textual outputs, synchronized caption outputs, synthesized speech outputs, visual accessibility outputs, browser-based communication outputs, conferencing communication outputs, telehealth communication outputs, or combinations thereof from common interpreted communication representations and to adapt at least one rendering parameter according to a user-associated accessibility profile.

26. The system of claim 23, further comprising one or more onboard edge-computing systems and one or more cloud communication systems configured to cooperatively synchronize interpreted communication representations, accessibility rendering states, token validation states, caption timing states, policy states, or combinations thereof across a plurality of heterogeneous communication endpoints and transportation-provider-managed communication environments.

27. The system of claim 23, wherein the distributed speech rehabilitation processing systems improve interpreted speech accuracy over time using continuously updated user-associated speech samples.

28. A non-transitory computer-readable storage medium storing instructions that, when executed by one or more processors associated with a transportation-provider-managed communication infrastructure, cause the one or more processors to:
process passenger-associated authorization credentials associated with a passenger-operated portable electronic communication device;
generate a communication authorization token associated with a real-time communication session;
establish the real-time communication session between the passenger-operated portable electronic communication device and at least one remote communication system;
dynamically allocate communication bandwidth resources according to communication priority classifications, accessibility classifications, communication congestion conditions, transportation-provider operational policies, or combinations thereof; and
selectively authorize, synchronize, prioritize, monetize, meter, revoke, suspend, terminate, interpret, render, or control the real-time communication session operating within a transportation-provider-managed communication environment.

29. The non-transitory computer-readable storage medium of claim 28, wherein the instructions further cause the one or more processors to synchronize interpreted speech outputs and synchronized caption outputs across a plurality of heterogeneous communication endpoints.

30. The non-transitory computer-readable storage medium of claim 28, wherein the instructions further cause the one or more processors to terminate the real-time communication session in response to an administrative override instruction received from a transportation-provider operator.
